(19) United States
(12) Patent Application Publication
(10) Pub. No.: US 2026/0057318 A1
(43) Pub. Date: Feb. 26, 2026

(54) SYSTEM AND METHOD FOR AUTOMATIC TASK CONTROL

(71) Applicant: WorkStarr, Inc., Attleboro, MA (US)

(72) Inventor: Joseph D. Rando, Sharon, MA (US)

(73) Assignee: WorkStarr, Inc., Attleboro, MA (US)

(21) Appl. No.: 18/811,167

(22) Filed: Aug. 21, 2024

(51) Int. Cl. G06Q 10/0631; G10L 15/26

(52) U.S. Cl. CPC G06Q 10/06313; G06Q 10/063112; G06Q 10/063114; G10L 15/26

(57) ABSTRACT

System and method for automatic task control are disclosed. The system includes at least a server, a receiving module, wherein the receiving module is configured receive a plurality of data sets from one or more data sources and extract contextual data associated with a plurality of tasks from the plurality of data sets, a context analyzing module, wherein the context analyzing module is configured to determine at least a configurable task modifier as a function of the contextual data and a task update module, wherein the task update module is configured to query the plurality of tasks to identify at least one task of the plurality of tasks as a function of the at least a configurable task modifier and update the at least one task as a function of the at least a configurable task modifier.

### FIELD OF THE INVENTION

The present invention generally relates to the field of artificial intelligence. In particular, the present invention is directed to a system and method for automatic task control.

### BACKGROUND

Traditional task management systems often rely on static data entry, where users manually input task details, deadlines, priorities, and other relevant information. These systems provide basic functionalities such as task creation, assignment, and tracking. However, they fall short in adapting to dynamic changes and contextual variations that occur in real-time project environments.

### SUMMARY OF THE DISCLOSURE

In an aspect, a system for automatic task control is disclosed. The system includes at least a server, a receiving module operating on the at least a server, wherein the receiving module is designed and configured to receive a plurality of data sets from one or more data sources and extract contextual data associated with a plurality of tasks from the plurality of data sets, a context analyzing module operating on the at least a server, wherein the context analyzing module is designed and configured to determine at least a configurable task modifier as a function of the contextual data and a task update module operating on the at least a server, wherein the task update module is designed and configured to query the plurality of tasks to identify at least one task of the plurality of tasks as a function of the at least a configurable task modifier and update the at least one task as a function of the at least a configurable task modifier.

In another aspect, a method for automatic task control is disclosed. The method includes receiving, using a receiving module operating on at least a server, a plurality of data sets from one or more data sources, extracting, using the receiving module, contextual data associated with a plurality of tasks from the plurality of data sets, determining, using a context analyzing module operating on the at least a server, at least a configurable task modifier as a function of the contextual data, querying, using a task update module operating on the at least a server, the plurality of tasks to identify at least one task of the plurality of tasks as a function of the at least a configurable task modifier and updating, using a task update module operating on the at least a server, the at least one task as a function of the at least a configurable task modifier.

These and other aspects and features of non-limiting embodiments of the present invention will become apparent to those skilled in the art upon review of the following description of specific non-limiting embodiments of the invention in conjunction with the accompanying drawings.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 illustrates a block diagram of an exemplary system for automatic task control;

FIG. 2 illustrates a configuration of an exemplary user interface of a remote device;

FIG. 3 illustrates an exemplary chatbot system;

FIG. 4 illustrates a block diagram of an exemplary machine-learning module;

FIG. 5 illustrates a diagram of an exemplary neural network;

FIG. 6 illustrates a block diagram of an exemplary node in a neural network;

FIG. 7 illustrates a flow diagram of an exemplary method for automatic task control; and

FIG. 8 illustrates a block diagram of a computing system that can be used to implement any one or more of the methodologies disclosed herein and any one or more portions thereof.

The drawings are not necessarily to scale and may be illustrated by phantom lines, diagrammatic representations and fragmentary views. In certain instances, details that are not necessary for an understanding of the embodiments or that render other details difficult to perceive may have been omitted.

### DETAILED DESCRIPTION

At a high level, aspects of the present disclosure are directed to systems and methods for automatic task control are disclosed. The system includes at least a server, a receiving module operating on the at least a server, wherein the receiving module is designed and configured to receive a plurality of data sets from one or more data sources and extract contextual data associated with a plurality of tasks from the plurality of data sets, a context analyzing module operating on the at least a server, wherein the context analyzing module is designed and configured to determine at least a configurable task modifier as a function of the contextual data and a task update module operating on the at least a server, wherein the task update module is designed and configured to query the plurality of tasks to identify at least one task of the plurality of tasks as a function of the at least a configurable task modifier and update the at least one task as a function of the at least a configurable task modifier. Exemplary embodiments illustrating aspects of the present disclosure are described below in the context of several specific examples.

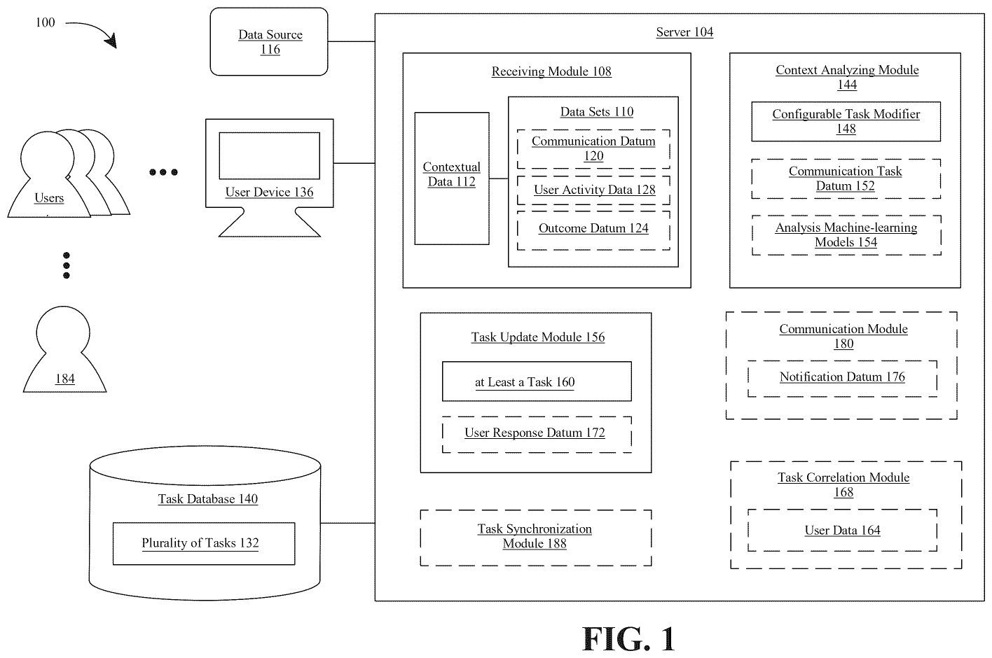

Referring now to FIG. 1, an exemplary embodiment of a system 100 for automatic task control is illustrated. System 100 includes at least a server 104. Server 104 may include, without limitation, any processor described in this disclosure. Server 104 may be included in a computing device. Server 104 may include any computing device as described in this disclosure, including without limitation a microcontroller, microprocessor, digital signal processor (DSP) and/or system on a chip (SoC) as described in this disclosure. Server 104 may include, be included in, and/or communicate with a mobile device such as a mobile telephone or smartphone. Server 104 may include a single computing device operating independently, or may include two or more computing device operating in concert, in parallel, sequentially or the like; two or more computing devices may be included together in a single computing device or in two or more computing devices. Server 104 may interface or communicate with one or more additional devices as described below in further detail via a network interface device. Network interface device may be utilized for connecting server 104 to one or more of a variety of networks, and one or more devices. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network may employ a wired and/or a wireless mode of communication. In general, any network topology may be used. Information (e.g., data, software etc.) may be communicated to and/or from a computer and/or a computing device. Server 104 may include but is not limited to, for example, a computing device or cluster of computing devices in a first location and a second computing device or cluster of computing devices in a second location. Server 104 may include one or more computing devices dedicated to data storage, security, distribution of traffic for load balancing, and the like. Server 104 May distribute one or more computing tasks as described below across a plurality of computing devices of computing device, which may operate in parallel, in series, redundantly, or in any other manner used for distribution of tasks or memory between computing devices. Server 104 may be implemented, as a non-limiting example, using a “shared nothing” architecture.

With continued reference to FIG. 1, server 104 may be designed and/or configured to perform any method, method step, or sequence of method steps in any embodiment described in this disclosure, in any order and with any degree of repetition. For instance, server 104 may be configured to perform a single step or sequence repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. Server 104 may perform any step or sequence of steps as described in this disclosure in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

With continued reference to FIG. 1, system 100 may include a memory communicatively connected to server 104. For the purposes of this disclosure, “communicatively connected” means connected by way of a connection, attachment or linkage between two or more relata which allows for reception and/or transmittance of information therebetween. For example, and without limitation, this connection may be wired or wireless, direct or indirect, and between two or more components, circuits, devices, systems, and the like, which allows for reception and/or transmittance of data and/or signal(s) therebetween. Data and/or signals therebetween may include, without limitation, electrical, electromagnetic, magnetic, video, audio, radio and microwave data and/or signals, combinations thereof, and the like, among others. A communicative connection may be achieved, for example and without limitation, through wired or wireless electronic, digital or analog, communication, either directly or by way of one or more intervening devices or components. Further, communicative connection may include electrically coupling or connecting at least an output of one device, component, or circuit to at least an input of another device, component, or circuit. For example, and without limitation, via a bus or other facility for intercommunication between elements of a computing device. Communicative connecting may also include indirect connections via, for example and without limitation, wireless connection, radio communication, low power wide area network, optical communication, magnetic, capacitive, or optical coupling, and the like. In some instances, the terminology “communicatively coupled” may be used in place of communicatively connected in this disclosure.

With continued reference to FIG. 1, system 100 includes a receiving module 108 operating on the at least a server 104. Receiving module 108 may include any suitable hardware or software module. “Receiving module” is a module that receives any input or data. Receiving module 108 is designed and configured to receive a plurality of data sets 110 from one or more data sources 116 and extract contextual data 112 associated with a plurality of tasks of a user. For the purposes of this disclosure, a “plurality of data sets” is a collection of data related to a user. For the purposes of this disclosure, a “user” is any person or individual that is using or has used a system. As a non-limiting example, user may include an employee, team member, and the like. For the purposes of this disclosure, “contextual data” is information that provides insights into the user's activities, or interactions related to the user's tasks. As a non-limiting example, plurality of data sets 110 may include a communication datum 120, outcome datum 124, user activity data 128, and the like as described in detail below. As a non-limiting example, contextual data 112 may encompass any changes in tasks 132 such as shifting deadlines, incoming communications, meeting outcomes, user roles, other user data associated with different email addresses, and the like.

With continued reference to FIG. 1, for the purposes of this disclosure, a “communication datum” is a data element that is related to information derived from communication channels. As a non-limiting example, communication channels may include emails, messaging platforms, phone call platforms, video call platforms, and the like. The communication channels described herein is further described below. As a non-limiting example, communication datum 120 may include actual message or information conveyed in the communication. This can include text, attachments, links, and other media. As a non-limiting example, communication datum 120 may include a record of a live-chat between users through communication channel. As another non-limiting example, communication datum 120 may include an email that is sent from one user to another user.

With continued reference to FIG. 1, for the purposes of this disclosure, an “outcome datum” is a data element that is related to a result or consequence of a specific action, event, or decision related to a task. In some cases, outcome datum 124 may include a lead time. For the purposes of this disclosure, a “lead time” is the time between the initiation and completion of a task. As a nonlimiting example, for a task 132 pertaining to ordering a custom-made mechanical part overseas, outcome datum 124 may include a lead time between 2 to 4 months. Outcome datum 124 may include binary indications such as “meeting the deadline” vs “missing the deadline”. Similarly, outcome datum 124 may include more specific details such “two days ahead of schedule” or ‘three days behind schedule.” Outcome datum 124 disclosed herein may be consistent with a predicted outcome described in Non-provisional application Ser. No. 18/811,034, filed on Aug. 21, 2024, and entitled “SYSTEM AND METHOD FOR AUTOMATED CONSOLIDATION AND DISTRIBUTION OF STRUCTURED DATA,” having an attorney docket of 1072-002USU1, the entirety of which is incorporated herein by reference.

With continued reference to FIG. 1, for the purposes of this disclosure, “user activity data” is data related to actions and behaviors of a user within a system or application. As a non-limiting example, user activity data 128 may include interaction data, usage patterns, engagement metrics, error and performance data, and customization and preferences. In some embodiments, user activity data 128 may include interactions of a user with a graphical user interface (GUI) element related to a plurality of tasks 132. As a non-limiting example, interaction data may record specific interactions a user has with an application or system, such as clicks on buttons, navigation through menus, and execution of commands. As a non-limiting example, user activity data 128 may include various actions and behaviors of users as they manage, adjust, and react to modifications in deadlines of tasks 132. Usage patterns may describe how frequently and in what manner a user engages with different parts of the system, including time spent on specific pages and frequency of feature usage. Engagement metrics may include quantitative measurements of user participation, such as the number of logins, session durations, and actions performed per session.

With continued reference to FIG. 1, for the purposes of this disclosure, a “task” is a work or activity that needs to be accomplished. A task 132 may include a personal task, work related task, community involvement task, and the like. For example, a task 132 may include a work-related task such as creating a rideable rocket toy for toddlers or surveying a rideable rocket toy market. In yet another non-limiting example, a task 132 may include a personal task such as obtaining a painter or setting up a weekly grocery allocation. A task 132 may include a community involvement task such as preparing foodstuffs for a local food pantry or organizing a charity softball tournament. A task 132 may relate to a hobby or leisure time activity such as an appointment with a personal trainer or participating in a spartan race. A task 132 may include a project and/or an action. A project as used herein includes a task that includes at least a sub-task. A “sub-task,” as used herein includes an element of a task that may be completed as part of a task. A sub-task may include a task 132 broken down into smaller steps. In an embodiment, sub-task may be broken down indefinitely into further sub-tasks. For example, a project such as creating a rideable rocket toy for toddlers may be broken down into sub-tasks that may include several steps necessary to complete the project. This may include for example, developing three rideable rocket toys, choosing a rideable rocket toy, building a prototype rideable rocket toy, performing a rideable rocket toy market analysis, finalizing a rideable rocket toy rollout plan, and producing and a rideable rocket toy. In yet another non-limiting example, a task 132 may be created by John G. that is described as finding a new maintenance worker for an air-conditioner. In such an instance, John G. may break down the task 132 into sub-tasks that include make a list of 3 companies, call companies to request a proposal, review proposals, and choose company. Sub-tasks may be assigned to other people as described below. For example, John G. may assign a sub-task such as to call workers to request proposal to his assistant, who may break that sub-task down further into three different sub-tasks, one for each individual that John G.'s assistant calls. An action as used herein includes a task that does not contain any sub-task. An action may include, for example, a task such as buying new shoes, or ordering wood. In an embodiment, an action may be completed in one step and may not contain any smaller steps that need to be completed in order to complete the action. In an embodiment, an action may be transformed into a project when a sub-task has been added and/or assigned.

With continued reference to FIG. 1, for the purposes of this disclosure, a “data source” is any place, system, tool, device or location from which data originates. In some embodiments, data source 116 may include a downstream device 136. For the purposes of this disclosure, a “downstream device” is any device or tool a user uses to input data. As a non-limiting example, downstream device 136 may include a laptop, desktop, tablet, mobile phone, smart phone, smart watch, kiosk, screen, smart headset, processor, computing device, or things of the like. In some embodiments, downstream device 136 may include a user interface configured to receive inputs from user. In some embodiments, user may manually input any data such as but not limited to contextual data 112, or the like into system 100 using downstream device 136. In some embodiments, user may have a capability to process, store or transmit any information independently. In some embodiments, data source 116 may include an application residing on downstream device 136. For the purposes of this disclosure, a “user interface” is a means by which a user and a computer system interact; for example through the use of input devices and software. A user interface may include a graphical user interface (GUI), command line interface (CLI), menu-driven user interface, touch user interface, voice user interface (VUI), form-based user interface, any combination thereof and the like. In some embodiments, user interface may operate on and/or be communicatively connected to a decentralized platform, metaverse, and/or a decentralized exchange platform associated with the user. For example, a user may interact with user interface in virtual reality. In some embodiments, a user may interact with the use interface using a computing device such as but not limited to downstream device 136, distinct from and communicatively connected to a server 104. In an embodiment, user interface may include a graphical user interface. A “graphical user interface,” as used herein, is a graphical form of user interface that allows entities to interact with electronic devices. In some embodiments, GUI may include icons, menus, other visual indicators or representations (graphics), audio indicators such as primary notation, and display information and related user controls. A menu may contain a list of choices and may allow entities to select one from them. A menu bar may be displayed horizontally across the screen such as pull-down menu. When any option is clicked in this menu, then the pull-down menu may appear. A menu may include a context menu that appears only when the user performs a specific action. An example of this is pressing the right mouse button. When this is done, a menu may appear under the cursor. Files, programs, web pages and the like may be represented using a small picture in a graphical user interface. For example, links to decentralized platforms as described in this disclosure may be incorporated using icons. Using an icon may be a fast way to open documents, run programs etc. because clicking on them yields instant access.

With continued reference to FIG. 1, in some embodiments, data source 116 may include a task database 140. In some embodiments, database may be implemented, without limitation, as a relational database, a key-value retrieval database such as a NOSQL database, or any other format or structure for use as a database that a person skilled in the art would recognize as suitable upon review of the entirety of this disclosure. Database may alternatively or additionally be implemented using a distributed data storage protocol and/or data structure, such as a distributed hash table or the like. Database may include a plurality of data entries and/or records as described above. Data entries in a database may be flagged with or linked to one or more additional elements of information, which may be reflected in data entry cells and/or in linked tables such as tables related by one or more indices in a relational database. Persons skilled in the art, upon reviewing the entirety of this disclosure, will be aware of various ways in which data entries in a database may store, retrieve, organize, and/or reflect data and/or records as used herein, as well as categories and/or populations of data consistently with this disclosure. In one or more embodiments, database may include inputted or calculated information and datum. As a non-limiting example, the datum history may include real-time and/or previous inputted data. In some embodiments, database may include instructions from a user, who may be an expert user, a past user in embodiments disclosed herein, or the like, where the instructions may include examples of the data related to tasks 132 or contextual data 112.

With continued reference to FIG. 1, in some embodiments, task database 140 may include keywords. As used in this disclosure, a “keyword” is an element of word or syntax used to identify and/or match elements to each other. For example, without limitation, the keyword may include user's name in the instance that user is looking for data related to user. For example, without limitation, the keyword may include a name of task 132 in the instance that user is looking for data related to task 132. In another non-limiting example, the keyword may include specific time in the instance that user is looking for data related to specific time.

With continued reference to FIG. 1, in some embodiments, database may include a task database 140. In some embodiments, data source 116 may include task database 140. As used in this disclosure, “task database” is a data structure configured to store data associated with a plurality of tasks. As a non-limiting example, task database 140 may store contextual data 112, communication datum 120, outcome datum 124, user activity data 128, and any data disclosed in this disclosure. In one or more embodiments, task database 140 may include inputted or calculated information and datum related to process or contextual data 112. In some embodiments, a datum history may be stored in task database 140. As a non-limiting example, the datum history may include real-time and/or previous inputted data to server 104 related to process or contextual data 112. As a non-limiting example, task database 140 may include instructions from a user, who may be an expert user, a past user in embodiments disclosed herein, or the like, where the instructions may include examples of the data related to user such as but not limited to contextual data 112, communication datum 120, outcome datum 124, user activity data 128, and any data disclosed in this disclosure.

With continued reference to FIG. 1, in some embodiments, task database 140 or any database may be communicatively connected with server 104. For example, and without limitation, in some cases, task database 140 may be local to server 104. In another example, and without limitation, task database 140 may be remote to server 104 and communicative with server 104 by way of one or more networks. The network may include, but is not limited to, a cloud network, a mesh network, and the like. By way of example, a “cloud-based” system can refer to a system which includes software and/or data which is stored, managed, and/or processed on a network of remote servers hosted in the “cloud,” e.g., via the Internet, rather than on local severs or personal computers. A “mesh network” as used in this disclosure is a local network topology in which the infrastructure server 104 connect directly, dynamically, and non-hierarchically to as many other computing devices as possible. A “network topology” as used in this disclosure is an arrangement of elements of a communication network. The network may use an immutable sequential listing to securely store task database 140. An “immutable sequential listing,” as used in this disclosure, is a data structure that places data entries in a fixed sequential arrangement, such as a temporal sequence of entries and/or blocks thereof, where the sequential arrangement, once established, cannot be altered or reordered. An immutable sequential listing may be, include and/or implement an immutable ledger, where data entries that have been posted to the immutable sequential listing cannot be altered.

With continued reference to FIG. 1, in some embodiments, data source 116 may include application programming interface (API). As used herein, an “application programming interface” is a set of functions that allow applications to access data and interact with external software components, operating systems, or microdevices, such as another web application or computing device. As a non-limiting example, API may include calendar, scheduling, time tracking, time management APIs, email APIs, messaging APIs, and other similar applications, or the like. As another non-limiting example, API may include project management APIs, note APIs, or the like. As another non-limiting example, API may include communication APIs, or the like.

With continued reference to FIG. 1, contextual data 112 may be received through user input, such and without limitations, by a user inputting or uploading contextual data 112 into a server 104. In some cases, system 100 may include an “add-on” software configured to be added to another software program. An “add-on” for the purposes of this disclosure is a feature allowing a device or a software to be added to an already existing device or software. The add-on may provide for enhanced features and/or added features. System 100 may be configured as an add-on for an existing website wherein a user may interact with apparatus without having to leave the current software program. In some cases, server 104 may receive contextual data 112 through an add-on feature of another program. For example, server 104 may automatically receive contextual data 112 based on a user's interaction with the software. A user may be using a website, modifying task 132 such as changing user's name, user's role, task deadline, and the like, wherein receiving module 108 receives contextual data 112. In some cases, user may interact with a feature within the software program to submit contextual data 112 to receiving module 108.

With continued reference to FIG. 1, system 100 includes a context analyzing module 144 operating on at least a server 104. A “context analyzer module,” as used herein, is a component or system that is designed and configured to determine at least a configurable task modifier. Context analyzing module 144 is configured to determine at least a configurable task modifier 148 as a function of contextual data 112. For the purposes of this disclosure, a “configurable task modifier” is a parameter of a task that can be changed or is intended to be changed. As a non-limiting example, configurable task modifier 148 may include due dates, priority levels, assigned resources, status, task description, start date of task 132, responsibility of users, user's position, or any other relevant task property related to a plurality of tasks 132. In some cases, at least a configurable task modifier 148 may include a temporal span. For the purposes of this disclosure, a “temporal span” is an indicator that indicates the start, end, and duration of an event or action. Temporal span may be useful for system 100 to coordinate a highly complex set of interdependent events or actions Alternatively, and/or additionally, at least a configurable task modifier 148 may include a matter owner. For the purposes of this disclosure, a “matter owner” is an indicator that indicates a party who initiates or creates certain events or actions or is otherwise in charge of or responsible for managing and distributing certain events or actions for downstream processing. Alternatively, and/or additionally, at least a configurable task modifier 148 may include an assignment. For the purposes of this disclosure, an “assignment” is an indicator that indicates a party who has been assigned to complete certain events or actions or is otherwise expected to report to a matter owner regarding certain events or actions.

Alternatively, and/or additionally, at least a configurable task modifier 148 may include a task type. For the purposes of this disclosure, a “task type” is an indicator that indicates the nature and/or status of an event or action. Additionally, and/or alternatively, configurable task modifier 148 may include any type of parameter not disclosed herein that are deemed suitable by a person of ordinary skill in the art upon reviewing the entirety of this disclosure.

With continued reference to FIG. 1, in some embodiments, receiving module 108 may receive communication datum 120 from a communication channel. In some embodiments, data source 116 may include communication channel. A “communication channel,” as used in this disclosure, is a communication medium within an interface. A communication channel may include an application, script, and/or program capable of providing a means of communication between at least two parties, including any oral and/or written forms of communication. As a non-limiting example, communication channel may include a phone call, video conference, in-person meeting, chat session, and the like. A communication channel may allow server 104 to interface with electronic devices through graphical icons, audio indicators including primary notation, text based user interfaces, typed command labels, text navigation, and the like. A communication channel may include slides or other commands that may allow a user to select one or more options. A communication channel may include free form textual entries, where a user may type or input in response and/or message. A communication channel may include a display interface. Display interface may include a form or other graphical element having display fields, where one or more elements of information may be displayed. Display interface may display data output fields including text, images, or the like containing one or more messages. A communication channel may include data input fields such as text entry windows, drop-down lists, buttons, checkboxes, radio buttons, sliders, links, or any other data input interface that may capture user interaction as may occur to persons skilled in the art upon reviewing the entirety of this disclosure. In some embodiments, data source 116 may include a chatbot. For the purposes of this disclosure, “chatbot” is an artificial intelligence (AI) program designed to simulate human conversation or interaction through text, voice-based or image-based communication.

With continued reference to FIG. 1, in some embodiments, data source 116 may include a plurality of machine-learning models. As a non-limiting example, data source 116 may include an outcome machine-learning module. In some embodiments, analysis machine-learning model may include outcome machine-learning module. The analysis machine-learning model is further described below. In some embodiments, receiving contextual data 112 may include receiving an outcome datum of the contextual data from an outcome machine-learning module of the one or more data sources. For the purposes of this disclosure, an “outcome machine-learning module” is a component or system that uses algorithm to generate an outcome datum. In some embodiments, outcome machine-learning module may be trained with outcome prediction training data. Implementation of outcome machine-learning module may be consistent with any type of machine-learning model or algorithm described in this disclosure. In one or more embodiments, outcome prediction training data may include data specifically synthesized for training purposes using one or more generative models. In one or more embodiments, previously used contextual data 112 or configurable task modifiers 148 may be incorporated into outcome prediction training data upon validation. In one or more embodiments, outcome prediction training data may be retrieved from one or more databases and/or other repositories of similar nature or be supplied as one or more inputs from one or more entities. In one or more embodiments, at least a portion of outcome prediction training data may be added, deleted, replaced, or otherwise updated as a function of one or more inputs from one or more entities. A person of ordinary skill in the art, upon reviewing the entirety of this disclosure, will be able to recognize suitable means to implement outcome machine-learning module in system 100. Additional disclosure related to an outcome machine-learning module may be found in Non-provisional application Ser. No. 18/811,034, filed on Aug. 21, 2024, and entitled “SYSTEM AND METHOD FOR AUTOMATED CONSOLIDATION AND DISTRIBUTION OF STRUCTURED DATA,” having an attorney docket of 1072-002USU1, the entirety of which is incorporated herein by reference.

With continued reference to FIG. 1, in some embodiments, server 104 may receive communication datum 120 in audio format from downstream device 136 through communication channel, and the like. In some embodiments, server 104 may retrieve communication datum 120 in audio format from task database 140. In some embodiments, determining at least a configurable task modifier 148 may include converting communication datum 120 in audio format to communication datum 120 in textual format using an automatic speech recognition and extracting contextual data 112 as a function of the communication datum 120 in the textual format.

With continued reference to FIG. 1, in some embodiments, context analyzing module 144 may convert communication datum 120 in audio format to communication datum 120 in textual format using automatic speech recognition (ASR). Communication datum 120 in textual format may be a written representation of spoken words, phrases, and other relevant audio elements of communication datum 120 in audio format. As a non-limiting example, ASR may analyze a record of a call or video call to obtain communication datum 120 in audio format. For the purposes of this disclosure, “automatic speech recognition” is a technology that converts spoken language into written text or machine-readable form. In a non-limiting example, context analyzing module 144 may use a record of a call or video call between users to aid in recognition of communication datum 120 in audio format. In some embodiments, ASR may include techniques employing language processing to aid speech recognition processes. In some cases, ASR may be used to decode (i.e., recognize) indeterministic phonemes or help in forming a preponderance among probabilistic candidates. In some cases, ASR may include an audio-based automatic speech recognition process and an image-based automatic speech recognition process. ASR may analysis audio according to any method described herein, for instance using a Mel frequency cepstral coefficients (MFCCs) and/or log-Mel spectrogram derived from raw audio samples. In some cases, feature recognition may include any feature recognition process described in this disclosure, for example a variant of a convolutional neural network. For instance, audio vector may each be concatenated and used to predict speech made by data provider of user.

With continued reference to FIG. 1, in some embodiments, automatic speech recognition may require training (i.e., enrollment). In some cases, training an automatic speech recognition model may require an individual speaker to read text or isolated vocabulary. In some cases, a solicitation video may include an audio component having communication datum 120 in audio format, the contents of which are known a priori by context analyzing module 144. Context analyzing module 144 may then train an automatic speech recognition model according to training data which includes communication datum 120 in audio format correlated to known content (e.g., communication datum 120 in textual format). In this way, context analyzing module 144 may analyze a person's specific voice and train an automatic speech recognition model to the person's speech, resulting in increased accuracy. Alternatively or additionally, in some cases, context analyzing module 144 may include an automatic speech recognition model that is speaker-independent. As used in this disclosure, a “speaker independent” automatic speech recognition process does not require training for each individual speaker. Conversely, as used in this disclosure, automatic speech recognition processes that employ individual speaker specific training are “speaker dependent.”

With continued reference to FIG. 1, in some embodiments, an automatic speech recognition process may perform voice recognition or speaker identification. As used in this disclosure, “voice recognition” refers to identifying a speaker, from audio content, rather than what the speaker is saying. In some cases, context analyzing module 144 may first recognize a speaker of communication datum 120 in audio format and then automatically recognize speech of the speaker, for example by way of a speaker dependent automatic speech recognition model or process. In some embodiments, an automatic speech recognition process can be used to authenticate or verify an identity of a speaker. In some cases, a speaker may or may not include subject. For example, subject may speak within solicitation video, but others may speak as well.

With continued reference to FIG. 1, in some embodiments, an automatic speech recognition process may include one or all of acoustic modeling, language modeling, and statistically-based speech recognition algorithms. In some cases, an automatic speech recognition process may employ hidden Markov models (HMMs). As discussed in greater detail below, language modeling such as that employed in natural language processing applications like document classification or statistical machine translation, may also be employed by an automatic speech recognition process.

With continued reference to FIG. 1, an exemplary algorithm employed in automatic speech recognition may include or even be based upon hidden Markov models. Hidden Markov models (HMMs) may include statistical models that output a sequence of symbols or quantities. HMMs can be used in speech recognition because a speech signal can be viewed as a piecewise stationary signal or a short-time stationary signal. For example, over a short time scale (e.g., 10 milliseconds), speech can be approximated as a stationary process. Speech (i.e., communication datum 120 in audio format) can be understood as a Markov model for many stochastic purposes.

With continued reference to FIG. 1, in some embodiments HMMs can be trained automatically and may be relatively simple and computationally feasible to use. In an exemplary automatic speech recognition process, a hidden Markov model may output a sequence of n-dimensional real-valued vectors (with n being a small integer, such as 10), at a rate of about one vector every 10 milliseconds. Vectors may consist of cepstral coefficients. A cepstral coefficient requires using a spectral domain. Cepstral coefficients may be obtained by taking a Fourier transform of a short time window of speech yielding a spectrum, decorrelating the spectrum using a cosine transform, and taking first (i.e., most significant) coefficients. In some cases, an HMM may have in each state a statistical distribution that is a mixture of diagonal covariance Gaussians, yielding a likelihood for each observed vector. In some cases, each word, or phoneme, may have a different output distribution; an HMM for a sequence of words or phonemes may be made by concatenating an HMMs for separate words and phonemes.

With continued reference to FIG. 1, in some embodiments, an automatic speech recognition process may use various combinations of a number of techniques in order to improve results. In some cases, a large-vocabulary automatic speech recognition process may include context dependency for phonemes. For example, in some cases, phonemes with different left and right context may have different realizations as HMM states. In some cases, an automatic speech recognition process may use cepstral normalization to normalize for different speakers and recording conditions. In some cases, an automatic speech recognition process may use vocal tract length normalization (VTLN) for male-female normalization and maximum likelihood linear regression (MLLR) for more general speaker adaptation. In some cases, an automatic speech recognition process may determine so-called delta and delta-delta coefficients to capture speech dynamics and might use heteroscedastic linear discriminant analysis (HLDA). In some cases, an automatic speech recognition process may use splicing and a linear discriminate analysis (LDA)-based projection, which may include heteroscedastic linear discriminant analysis or a global semi-tied covariance transform (also known as maximum likelihood linear transform [MLLT]). In some cases, an automatic speech recognition process may use discriminative training techniques, which may dispense with a purely statistical approach to HMM parameter estimation and instead optimize some classification-related measure of training data; examples may include maximum mutual information (MMI), minimum classification error (MCE), and minimum phone error (MPE).

With continued reference to FIG. 1, in some embodiments, an automatic speech recognition process may be said to decode speech (e.g., communication datum 120 in audio format). Decoding of speech may occur when an automatic speech recognition system is presented with a new utterance and must compute a most likely sentence. In some cases, speech decoding may include a Viterbi algorithm. A Viterbi algorithm may include a dynamic programming algorithm for obtaining a maximum a posteriori probability estimate of a most likely sequence of hidden states (i.e., Viterbi path) that results in a sequence of observed events. Viterbi algorithms may be employed in context of Markov information sources and hidden Markov models. A Viterbi algorithm may be used to find a best path, for example using a dynamically created combination hidden Markov model, having both acoustic and language model information, using a statically created combination hidden Markov model (e.g., finite state transducer [FST] approach).

With continued reference to FIG. 1, in some embodiments, speech (e.g., communication datum 120 in audio format) decoding may include considering a set of good candidates and not only a best candidate, when presented with a new utterance. In some cases, a better scoring function (i.e., re-scoring) may be used to rate each of a set of good candidates, allowing selection of a best candidate according to this refined score. In some cases, a set of candidates can be kept either as a list (i.e., N-best list approach) or as a subset of models (i.e., a lattice). In some cases, re-scoring may be performed by optimizing Bayes risk (or an approximation thereof). In some cases, re-scoring may include optimizing for sentence (including keywords) that minimizes an expectancy of a given loss function with regards to all possible transcriptions. For example, re-scoring may allow selection of a sentence that minimizes an average distance to other possible sentences weighted by their estimated probability. In some cases, an employed loss function may include Levenshtein distance, although different distance calculations may be performed, for instance for specific tasks. In some cases, a set of candidates may be pruned to maintain tractability.

With continued reference to FIG. 1, in some embodiments, an automatic speech recognition process may employ dynamic time warping (DTW)-based approaches. Dynamic time warping may include algorithms for measuring similarity between two sequences, which may vary in time or speed. For instance, similarities in walking patterns would be detected, even if in one video the person was walking slowly and if in another he or she were walking more quickly, or even if there were accelerations and deceleration during the course of one observation. DTW has been applied to video, audio, and graphics-indeed, any data that can be turned into a linear representation can be analyzed with DTW. In some cases, DTW may be used by an automatic speech recognition process to cope with different speaking (i.e., communication datum 120 in audio format) speeds. In some cases, DTW may allow context analyzing module 144 to find an optimal match between two given sequences (e.g., time series) with certain restrictions. That is, in some cases, sequences can be “warped” non-linearly to match each other. In some cases, a DTW-based sequence alignment method may be used in context of hidden Markov models.

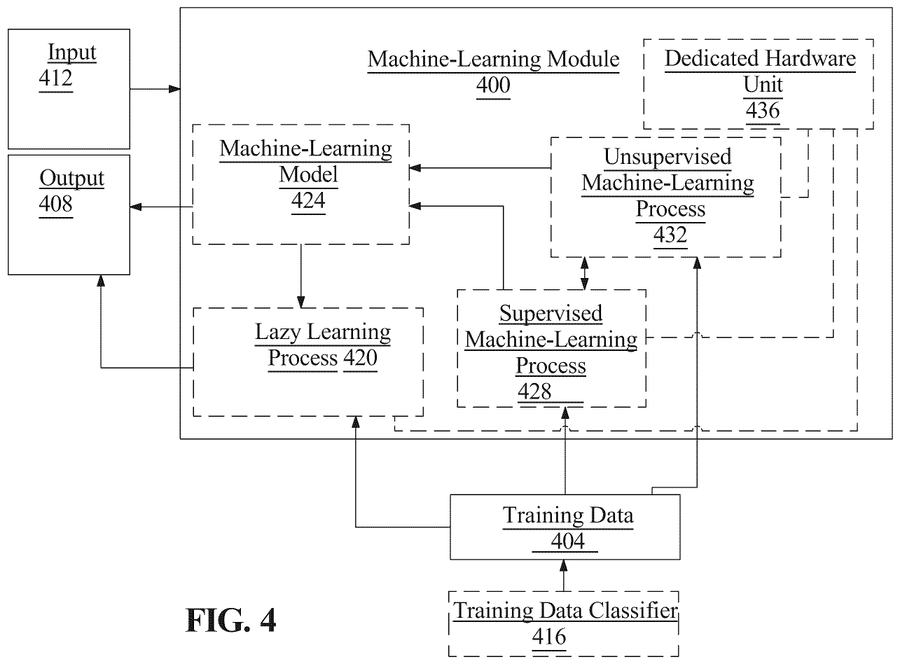

With continued reference to FIG. 1, in some embodiments, an automatic speech recognition process may include a neural network. Neural network may include any neural network, for example those disclosed with reference to FIGS. 4-6. In some cases, neural networks may be used for automatic speech recognition, including phoneme classification, phoneme classification through multi-objective evolutionary algorithms, isolated word recognition, audiovisual speech recognition, audiovisual speaker recognition and speaker adaptation. In some cases. neural networks employed in automatic speech recognition may make fewer explicit assumptions about feature statistical properties than HMMs and therefore may have several qualities making them attractive recognition models for speech recognition. When used to estimate the probabilities of a speech feature segment, neural networks may allow discriminative training in a natural and efficient manner. In some cases, neural networks may be used to effectively classify communication datum 120 in audio format over short-time interval, for instance such as individual phonemes and isolated words. In some embodiments, a neural network may be employed by automatic speech recognition processes for pre-processing, feature transformation and/or dimensionality reduction, for example prior to HMM-based recognition. In some embodiments, long short-term memory (LSTM) and related recurrent neural networks (RNNs) and Time Delay Neural Networks (TDNN's) may be used for automatic speech recognition, for example over longer time intervals for continuous speech recognition.

With continued reference to FIG. 1, in some embodiments, context analyzing module 144 may use a language processing module to find a communication task datum 152. For the purposes of this disclosure, a “communication task datum” is a data element related to a keyword extracted from contextual data in textual format. In some embodiments, communication task datum 152 may be directly related to modifying parameters of tasks 132 (e.g., configurable task modifier 148). In some embodiments, context analyzing module 144 may determine configurable task modifier 148 as a function of communication task datum 152. As a non-limiting example, communication task datum 152 may include “complete until Monday,” “update,” “review,” “modify,” “reassign to a person A,” “change person A's position to manager,” or “deadline.” In some embodiments, communication task datum 152 may be stored in task database 140. In some embodiments, context analyzing module 144 may retrieve communication task datum 152 from task database 140. In some embodiments, user may manually input communication task datum 152.

With continued reference to FIG. 1, for the purposes of this disclosure, a “language processing module” is a component designed to analyze, interpret, and manipulate human language. In some embodiments, language processing module may be configured to extract one or more words (e.g., communication task datum 152) from contextual data 112 in textual format. One or more words may include, without limitation, strings of one or more characters, including without limitation any sequence or sequences of letters, numbers, punctuation, diacritic marks, abbreviations, engineering symbols, chemical symbols and formulas, spaces, whitespace, and other symbols, including any symbols usable as textual data (e.g., contextual data 112 in textual format). Textual data may be parsed into tokens, which may include a simple word (sequence of letters separated by whitespace) or more generally a sequence of characters as described previously. The term “token,” as used herein, refers to any smaller, individual groupings of text from a larger source of text; tokens may be broken up by word, pair of words, sentence, or other delimitation. These tokens may in turn be parsed in various ways. Textual data may be parsed into words or sequences of words, which may be considered words as well. Textual data may be parsed into “n-grams”, where all sequences of n consecutive characters are considered. Any or all possible sequences of tokens or words may be stored as “chains”, for example for use as a Markov chain or Hidden Markov Model.

With continued reference to FIG. 1, language processing module may operate to produce a language processing model. Language processing model may include a program automatically generated by context analyzing module 144 and/or language processing module to produce associations between one or more words extracted from at least a document and detect associations, including without limitation mathematical associations, between such words. Associations between language elements, where language elements include for purposes herein extracted words, relationships of such categories to other such term may include, without limitation, mathematical associations, including without limitation statistical correlations between any language element and any other language element and/or language elements. Statistical correlations and/or mathematical associations may include probabilistic formulas or relationships indicating, for instance, a likelihood that a given extracted word indicates a given category of semantic meaning. As a further example, statistical correlations and/or mathematical associations may include probabilistic formulas or relationships indicating a positive and/or negative association between at least an extracted word and/or a given semantic meaning; positive or negative indication may include an indication that a given document is or is not indicating a category semantic meaning. Whether a phrase, sentence, word, or other textual element in a document or corpus of documents constitutes a positive or negative indicator may be determined, in an embodiment, by mathematical associations between detected words, comparisons to phrases and/or words indicating positive and/or negative indicators that are stored in memory at computing device, or the like.

With continued reference to FIG. 1, language processing module may generate the language processing model by any suitable method, including without limitation a natural language processing classification algorithm; language processing model may include a natural language process classification model that enumerates and/or derives statistical relationships between input terms and output terms. Algorithm to generate language processing model may include a stochastic gradient descent algorithm, which may include a method that iteratively optimizes an objective function, such as an objective function representing a statistical estimation of relationships between terms, including relationships between input terms and output terms, in the form of a sum of relationships to be estimated. In an alternative or additional approach, sequential tokens may be modeled as chains, serving as the observations in a Hidden Markov Model (HMM). HMMs, as used herein, are statistical models with inference algorithms that that may be applied to the models. In such models, a hidden state to be estimated may include an association between an extracted words, phrases, and/or other semantic units. There may be a finite number of categories to which an extracted word may pertain; an HMM inference algorithm, such as the forward-backward algorithm or the Viterbi algorithm, may be used to estimate the most likely discrete state given a word or sequence of words. Language processing module may combine two or more approaches. For instance, and without limitation, machine-learning program may use a combination of Naive-Bayes (NB), Stochastic Gradient Descent (SGD), and parameter grid-searching classification techniques; the result may include a classification algorithm that returns ranked associations.

With continued reference to FIG. 1, generating language processing model may include generating a vector space, which may be a collection of vectors, defined as a set of mathematical objects that can be added together under an operation of addition following properties of associativity, commutativity, existence of an identity element, and existence of an inverse element for each vector, and can be multiplied by scalar values under an operation of scalar multiplication compatible with field multiplication, and that has an identity element is distributive with respect to vector addition, and is distributive with respect to field addition. Each vector in an n-dimensional vector space may be represented by an n-tuple of numerical values. Each unique extracted word and/or language element as described above may be represented by a vector of the vector space. In an embodiment, each unique extracted and/or other language element may be represented by a dimension of vector space; as a non-limiting example, each element of a vector may include a number representing an enumeration of co-occurrences of the word and/or language element represented by the vector with another word and/or language element. Vectors may be normalized, scaled according to relative frequencies of appearance and/or file sizes. In an embodiment associating language elements to one another as described above may include computing a degree of vector similarity between a vector representing each language element and a vector representing another language element; vector similarity may be measured according to any norm for proximity and/or similarity of two vectors, including without limitation cosine similarity, which measures the similarity of two vectors by evaluating the cosine of the angle between the vectors, which can be computed using a dot product of the two vectors divided by the lengths of the two vectors. Degree of similarity may include any other geometric measure of distance between vectors.

With continued reference to FIG. 1, language processing module may use a corpus of documents to generate associations between language elements in a language processing module may then use such associations to analyze words extracted from contextual data 112 in textual format and determine that the one or more documents indicate significance of a category. In an embodiment, language module and/or context analyzing module 144 may perform this analysis using a selected set of significant documents, such as documents identified by one or more experts as representing good information; experts may identify or enter such documents via graphical user interface or may communicate identities of significant documents according to any other suitable method of electronic communication, or by providing such identity to other persons who may enter such identifications into context analyzing module 144. Documents may be entered into a computing device by being uploaded by an expert or other persons using, without limitation, file transfer protocol (FTP) or other suitable methods for transmission and/or upload of documents; alternatively or additionally, where a document is identified by a citation, a uniform resource identifier (URI), uniform resource locator (URL) or other datum permitting unambiguous identification of the document, context analyzing module 144 may automatically obtain the document using such an identifier, for instance by submitting a request to a database or compendium of documents such as JSTOR as provided by Ithaka Harbors, Inc. of New York.

With continued reference to FIG. 1, in some embodiments, context analyzing module 144 may include a plurality of analysis machine-learning models 154. For the purposes of this disclosure, an “analysis machine-learning model” is a machine-learning model that determines configurable task modifier based on contextual device from a data source. In some embodiments, each of the plurality of analysis machine-learning models 154 may be configured to analyze contextual data 112 from a different data source of the one or more data sources 116. In a non-limiting example, first analysis machine-learning model may determine configurable task modifier 148 as a function of communication datum 120 received from a communication channel while second analysis machine-learning model may determine configurable task modifier 148 as a function of outcome datum 124. For instance, one analysis machine-learning model 154 might be optimized for natural language processing of email content, while another analysis machine-learning model 154 might be designed to interpret calendar events and schedules (e.g., user activity data 128). In some embodiments, each analysis machine-learning model 154 may be trained to analyze the specific characteristics and formats of contextual data 112 from its data source 116, ensuring specialized and accurate analysis. In some embodiments, context analyzing module 144 may be configured to generate analysis training data. In a non-limiting example, analysis training data may include correlations between exemplary contextual data and exemplary configurable task modifiers. In some embodiments, analysis training data may be stored in task database 140. In some embodiments, analysis training data may be received from one or more users, task database 140, external computing devices, and/or previous iterations of processing. As a non-limiting example, analysis training data may include instructions from a user, who may be an expert user, a past user in embodiments disclosed herein, or the like, which may be stored in memory and/or stored in task database 140, where the instructions may include labeling of training examples. In some embodiments, analysis training data may be updated iteratively on a feedback loop. As a non-limiting example, context analyzing module 144 may update analysis training data iteratively through a feedback loop as a function of contextual data 112, output of analysis machine-learning models 154 or other machine-learning models, or the like. In some embodiments, context analyzing module 144 may be configured to generate analysis machine-learning model 154. In a non-limiting example, generating analysis machine-learning model 154 may include training, retraining, or fine-tuning analysis machine-learning model 154 using analysis training data or updated analysis training data. In some embodiments, context analyzing module 144 may be configured to determine configurable task modifier 148 using analysis machine-learning model 154 (i.e. trained or updated analysis machine-learning model 154).

With continued reference to FIG. 1, system 100 includes a task update module 156 operating on at least a server 104. For the purposes of this disclosure, a “task update module” is a component that updates a task. Task update module 156 is designed and configured to query at least a task 160 from a plurality of tasks 132 stored in a task database 140 as a function of at least a configurable task modifier 148 and update the at least a task 160 as a function of the at least a configurable task modifier 148. In a non-limiting example, task update module 156 may query task 160 that is related to configurable task modifier 148 from task database 140. For example, and without limitation, task update module 156 may retrieve a task 160 related to meeting A using a configurable task modifier 148 that includes a name of meeting A and meeting B. In some embodiments, task 160 may be a task that is subject to adjustment or modification based on a configurable task modifier. As a non-limiting example, task 160 may represent an actionable item or a unit of work that is managed through the system, requiring updates to its parameters such as due dates, priorities, resources, or status. Task update module 156 may give a weight to a plurality of tasks 132, configurable task modifier 148 or communication task datum 152 when searching through task database 140 and/or other databases. “Weights,” as used herein, are multipliers or other scalar numbers reflecting a relative importance of a particular attribute or value. A weight may include, but is not limited to, a numerical value corresponding to an importance of an element. In some embodiments, a weighted value may be referred to in terms of a whole number, such as 0, 100, and the like. As a non-limiting example, a weighted value of 0.2 may indicate that the weighted value makes up 20% of the total value. Task update module 156 may give a weight of 0.8 to the words “task A” and a weight of 0.2 to the word “task B” for a certain configurable task modifier 148. Task update module 156 may map a plurality of task 132 having similar attributes to the word “task A” with differing attributes than the word “task B” due to the lower weight value paired to the word “task B.” In some embodiments, task update module 156 may pair one or more weighted values to a plurality of tasks 132. Weighted values may be tuned through a machine-learning model. In some embodiments, task update module 156 may generate weighted values based on historical data. For the purposes of this disclosure, “historical data” is data previously collected data about past events, activities, or transactions within a system. In some embodiments, historical data may include prior queries. As a non-limiting example, prior queries may include the actual search terms or phrases entered by users or systems, number of times a particular query or similar queries have been made, and the like. In some embodiments, task update module 156 may be configured to filter out one or more “stop words” that may not convey meaning, such as “of,” “a,” “an,” “the,” or the like.

With continued reference to FIG. 1, in some embodiments, task update module 156 may modify or adjust a specific task (e.g., task 160) based on a particular change or input (e.g., configurable task modifier 148). In a non-limiting example, task 160 may include a task 132 labeled “Submit Quarterly Report,” with parameters including a due date of July 20th, assigned to John Doe, with a high priority and a configurable task modifier 148 may include ‘due date’ and ‘extended to July 25th.’ contextual data 112 including an email from the project manager stating that the report's due date needs to be extended to July 25th. Task update module 156 may update task 160 to have the due date from July 20th to July 25th.

With continued reference to FIG. 1, in some embodiments, updating at least a task 160 may include receiving user data 164 related of a plurality of users, determining, using a task correlation module 168 operating on at least a server 104, at least one user identifier 184 from the plurality of users as a function of the user data 164 and at least a configurable task modifier 148 and updating at least a task 160 related to the at least a user identifier 184. For the purposes of this disclosure, “user data” is data related to a plurality of users. As a non-limiting example, user data 164 may include roles, skills, availability, and other relevant attributes of users. In a non-limiting example, receiving module 108 may receive user data 164 indicating that John Doc is a “Project Manager” with expertise in budget management, and Jane Smith is a “Senior Developer” with availability for the next two weeks. For the purposes of this disclosure, a “task correlation module” is a module that uses user data and a configurable task modifier to determine the most suitable user(s) (user identifiers) for a given task. In a non-limiting example, task correlation module 168 may use information about user roles, skills, and availability to determine that Jane Smith should be assigned a specific development task because she has the required skills and availability. In a non-limiting example, task correlation module 168 may determine that Jane Smith should own the task “Develop New Feature” because she is a Senior Developer available for the next two weeks. Task correlation module 168 may update the task “Develop New Feature” to be assigned to Jane Smith and adjusting the task's start and end dates based on her availability.

With continued reference to FIG. 1, in some embodiments, updating at least a task 160 may include receiving a user response datum 172 related to at least a configurable task modifier 148, wherein the user response datum 172 may include an action modification and updating at least a task 160 as a function of the user response datum 172. For the purposes of this disclosure, a “user response datum” is a feedback or input provided by a user in response to a change or suggestion related to a task. As a non-limiting example, a user may respond to a notification datum 176 about a deadline change by suggesting a new deadline or altering the task's priority. For the purposes of this disclosure, an “action modification” is a change or adjustment proposed by a user for a task. As a non-limiting example, user response datum 172 may include an action acceptance where a user agrees to take on the updated task 160 as it is, action rejection where a user declines the updated task and action modification where a user alters updated task, which could include changing configurable task modifier 148. In a non-limiting example, task update module 156 may change the task's deadline or reassigns the task to another team member as suggested by the user (e.g., action modification).

With continued reference to FIG. 1, system 100 may include a communication module 180 operating on at least a server 104. For the purposes of this disclosure, a “communication module” is a module that transmit data to a downstream device, Communication module 180 may include any suitable hardware or software module. In some embodiments, communication module 180 may generate a notification datum 176 as a function of update of at least a task 160 and transmit the notification datum 176 to at least a downstream device 136. For the purposes of this disclosure, a “notification datum” is a data element for communicating information related to tasks to a user. As a non-limiting example, notification datum 176 may include a reminder, notification, and the like. For example, and without limitation, notification datum 176 may be configured to notify a user a current status, progress, or completion of tasks 132, automatable task identification, execution status, any issues encountered, and actions taken. As a non-limiting example, notification datum 176 may include email, SMS, push notifications, or in-app alerts. In some embodiments, communication module 180 may transmit notification datum 176 depending on user preferences, the urgency of the notification, and the nature of the task. In a non-limiting illustrative example, upon the update of task 160 by a task update module 156, communication module 180 may generate a notification datum 176 indicating that task 160 has been successfully updated. The notification datum 176 may be then transmitted to the relevant employee's device (e.g., downstream device 136 related to user identifier 184) via email and push notification. The employee may receive the update, confirms the meeting time, and acknowledge the notification, ensuring that all parties are informed and aligned.

With continued reference to FIG. 1, system 100 may include a task synchronization module 188 operative on at least a server 104. For the purposes of this disclosure, a “task synchronization module” is a module that is designed and configured to update at least a task of a plurality of tasks in a task database. In some embodiments, task synchronization module 188 may be designed and configured to update at least a task 160 of a plurality of tasks 132 in a task database 140 as a function of at least an updated task 160. In some embodiments, communication module 180 may be further designed and configured to transmit the plurality of updated tasks 160 to at least a downstream device 136. In some embodiments, task synchronization module 188 may ensure consistency and synchronization of tasks 132 across different platforms and devices. As a non-limiting example, task synchronization module 188 may update tasks 132 in task database 140 based on changes to tasks 160 and may ensure that these updates are propagated throughout system 100. In a non-limiting example, when a specific task 160 is updated, task synchronization module 188 can ensure that this update is reflected across all instances of the task 132 in task database 140. For example, and without limitation, the due date for the task “Complete Quarterly Report” is changed from July 20th to July 25th, the task synchronization module updates this change in the task database.

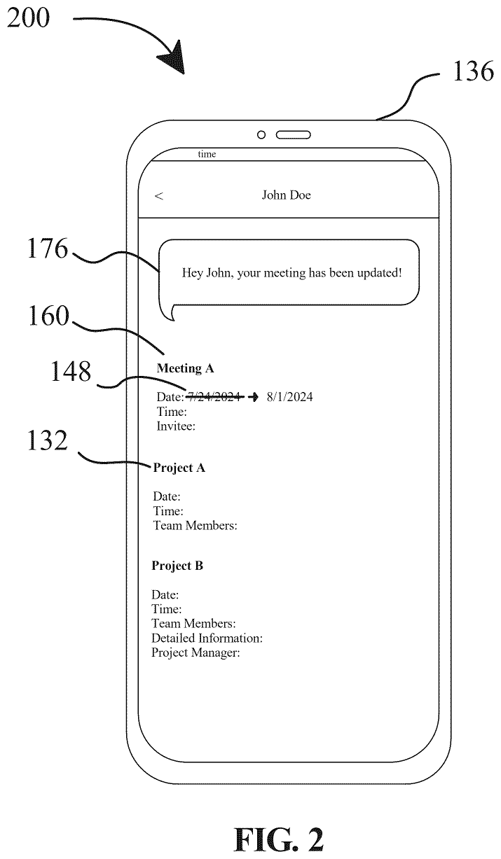

Referring now to FIG. 2, a configuration of an exemplary user interface 200 of a downstream device 136 is illustrated. In some embodiments, user interface 200 may display task 132, task 160, configurable task modifier 148, notification datum 176, and the like. A task 132 may include a personal task, work related task, community involvement task, and the like. For example, a task 132 may include a work-related task such as project meeting, creating a rideable rocket toy for toddlers or surveying a rideable rocket toy market. As a non-limiting example, configurable task modifier 148 may include due dates, priority levels, assigned resources, status, task description, start date of task 132, responsibility of users, user's position, or any other relevant task property related to a plurality of tasks 132. As a non-limiting example, notification datum 176 may include a reminder, notification, and the like. For example, and without limitation, notification datum 176 may be configured to notify a user a current status, progress, or completion of tasks 132, automatable task identification, execution status, any issues encountered, and actions taken. As a non-limiting example, notification datum 176 may include email, SMS, push notifications, or in-app alerts. In some embodiments, communication module 180 may transmit notification datum 176 depending on user preferences, the urgency of the notification, and the nature of the task. In a non-limiting illustrative example, upon the update of task 160 by a task update module 156, communication module 180 may generate a notification datum 176 indicating that task 160 has been successfully updated. The notification datum 176 may be then transmitted to the relevant employee's device (e.g., downstream device 136 related to user identifier 184) via email and push notification. The employee may receive the update, confirms the meeting time, and acknowledge the notification, ensuring that all parties are informed and aligned.

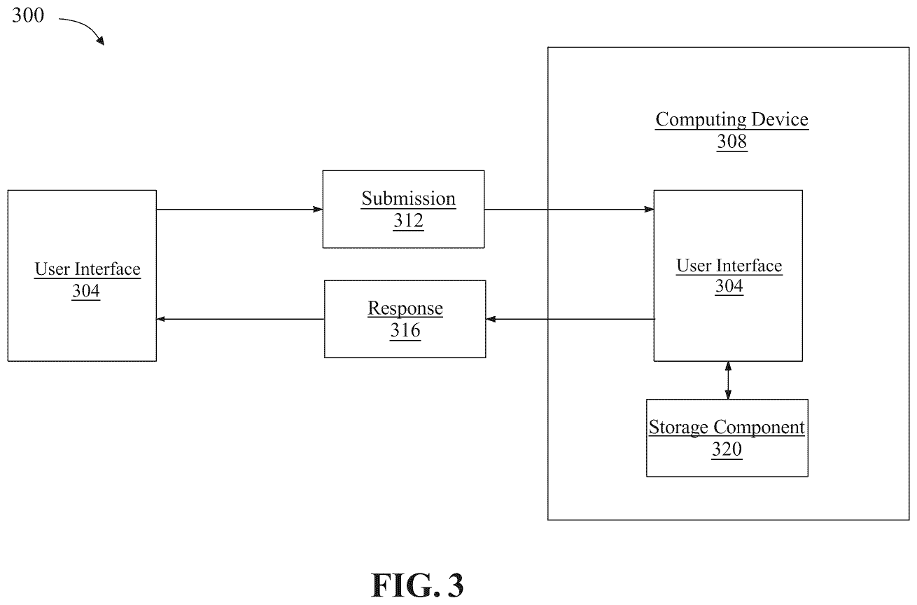

Referring now to FIG. 3, a chatbot system 300 is schematically illustrated. According to some embodiments, a user interface 304 may be communicative with a computing device 308 that is configured to operate a chatbot. Computing device 308 may be consistent with server 104. User interface 304 may be consistent with downstream device 136. In some cases, user interface 304 may be local to computing device 308. Alternatively or additionally, in some cases, user interface 304 may remote to computing device 308 and communicative with the computing device 308, by way of one or more networks, such as without limitation the internet. Alternatively or additionally, user interface 304 may communicate with user interface 304 using telephonic devices and networks, such as without limitation fax machines, short message service (SMS), or multimedia message service (MMS). Commonly, user interface 304 communicates with computing device 308 using text-based communication, for example without limitation using a character encoding protocol, such as American Standard for Information Interchange (ASCII). Typically, a user interface 304 conversationally interfaces a chatbot, by way of at least a submission 312, from the user interface 304 to the chatbot, and a response 316, from the chatbot to the user interface 304. In many cases, one or both of submission 312 and response 316 are text-based communication. Alternatively or additionally, in some cases, one or both of submission 312 and response 316 are audio-based communication.

Continuing in reference to FIG. 3, a submission 312 once received by computing device 308 operating a chatbot, may be processed by a processor. In some embodiments, processor processes a submission 312 using one or more of keyword recognition, pattern matching, and natural language processing. In some embodiments, processor employs real-time learning with evolutionary algorithms. In some cases, processor may retrieve a pre-prepared response from at least a storage component 320, based upon submission 312. Alternatively or additionally, in some embodiments, processor communicates a response 316 without first receiving a submission 312, thereby initiating conversation. In some cases, processor communicates an inquiry to user interface 304; and the processor is configured to process an answer to the inquiry in a following submission 312 from the user interface 304. In some cases, an answer to an inquiry present within a submission 312 from a user interface 304 may be used by computing device 308 as an input to another function.

With continued reference to FIG. 3, a chatbot may be configured to provide a user with a plurality of options as an input into the chatbot. Chatbot entries may include multiple choice, short answer response, true or false responses, and the like. A user may decide on what type of chatbot entries are appropriate. In some embodiments, the chatbot may be configured to allow the user to input a freeform response into the chatbot. The chatbot may then use a decision tree, data base, or other data structure to respond to the users entry into the chatbot as a function of a chatbot input. As used in the current disclosure, “chatbot input” is any response that a user inputs in to a chatbot as a response to a prompt or question.

With continuing reference to FIG. 3, computing device 308 may be configured to the respond to a chatbot input using a decision tree. A “decision tree,” as used in this disclosure, is a data structure that represents and combines one or more determinations or other computations based on and/or concerning data provided thereto, as well as earlier such determinations or calculations, as nodes of a tree data structure where inputs of some nodes are connected to outputs of others. Decision tree may have at least a root node, or node that receives data input to the decision tree, corresponding to at least a candidate input into a chatbot. Decision tree has at least a terminal node, which may alternatively or additionally be referred to herein as a “leaf node,” corresponding to at least an exit indication; in other words, decision and/or determinations produced by decision tree may be output at the at least a terminal node. Decision tree may include one or more internal nodes, defined as nodes connecting outputs of root nodes to inputs of terminal nodes. Computing device 308 may generate two or more decision trees, which may overlap; for instance, a root node of one tree may connect to and/or receive output from one or more terminal nodes of another tree, intermediate nodes of one tree may be shared with another tree, or the like.

Still referring to FIG. 3, computing device 308 may build decision tree by following relational identification; for example, relational indication may specify that a first rule module receives an input from at least a second rule module and generates an output to at least a third rule module, and so forth, which may indicate to computing device 308 an in which such rule modules will be placed in decision tree. Building decision tree may include recursively performing mapping of execution results output by one tree and/or subtree to root nodes of another tree and/or subtree, for instance by using such execution results as execution parameters of a subtree. In this manner, computing device 308 may generate connections and/or combinations of one or more trees to one another to define overlaps and/or combinations into larger trees and/or combinations thereof. Such connections and/or combinations may be displayed by visual interface to user, for instance in first view, to enable viewing, editing, selection, and/or deletion by user; connections and/or combinations generated thereby may be highlighted, for instance using a different color, a label, and/or other form of emphasis aiding in identification by a user. In some embodiments, subtrees, previously constructed trees, and/or entire data structures may be represented and/or converted to rule modules, with graphical models representing them, and which may then be used in further iterations or steps of generation of decision tree and/or data structure. Alternatively or additionally subtrees, previously constructed trees, and/or entire data structures may be converted to APIs to interface with further iterations or steps of methods as described in this disclosure. As a further example, such subtrees, previously constructed trees, and/or entire data structures may become remote resources to which further iterations or steps of data structures and/or decision trees may transmit data and from which further iterations or steps of generation of data structure receive data, for instance as part of a decision in a given decision tree node.

Continuing to refer to FIG. 3, decision tree may incorporate one or more manually entered or otherwise provided decision criteria. Decision tree may incorporate one or more decision criteria using an application programmer interface (API). Decision tree may establish a link to a remote decision module, device, system, or the like. Decision tree may perform one or more database lookups and/or look-up table lookups. Decision tree may include at least a decision calculation module, which may be imported via an API, by incorporation of a program module in source code, executable, or other form, and/or linked to a given node by establishing a communication interface with one or more exterior processes, programs, systems, remote devices, or the like; for instance, where a user operating system has a previously existent calculation and/or decision engine configured to make a decision corresponding to a given node, for instance and without limitation using one or more elements of domain knowledge, by receiving an input and producing an output representing a decision, a node may be configured to provide data to the input and receive the output representing the decision, based upon which the node may perform its decision.

Referring now to FIG. 4, an exemplary embodiment of a machine-learning module 400 that may perform one or more machine-learning processes as described in this disclosure is illustrated. Machine-learning module may perform determinations, classification, and/or analysis steps, methods, processes, or the like as described in this disclosure using machine-learning processes. A “machine-learning process,” as used in this disclosure, is a process that automatedly uses training data 404 to generate an algorithm instantiated in hardware or software logic, data structures, and/or functions that will be performed by a computing device/module to produce outputs 408 given data provided as inputs 412; this is in contrast to a non-machine-learning software program where the commands to be executed are determined in advance by a user and written in a programming language.

Still referring to FIG. 4, “training data,” as used herein, is data containing correlations that a machine-learning process may use to model relationships between two or more categories of data elements. For instance, and without limitation, training data 404 may include a plurality of data entries, also known as “training examples,” each entry representing a set of data elements that were recorded, received, and/or generated together; data elements may be correlated by shared existence in a given data entry, by proximity in a given data entry, or the like. Multiple data entries in training data 404 may evince one or more trends in correlations between categories of data elements; for instance, and without limitation, a higher value of a first data element belonging to a first category of data element may tend to correlate to a higher value of a second data element belonging to a second category of data element, indicating a possible proportional or other mathematical relationship linking values belonging to the two categories. Multiple categories of data elements may be related in training data 404 according to various correlations; correlations may indicate causative and/or predictive links between categories of data elements, which may be modeled as relationships such as mathematical relationships by machine-learning processes as described in further detail below. Training data 404 may be formatted and/or organized by categories of data elements, for instance by associating data elements with one or more descriptors corresponding to categories of data elements. As a non-limiting example, training data 404 may include data entered in standardized forms by persons or processes, such that entry of a given data element in a given field in a form may be mapped to one or more descriptors of categories. Elements in training data 404 may be linked to descriptors of categories by tags, tokens, or other data elements; for instance, and without limitation, training data 404 may be provided in fixed-length formats, formats linking positions of data to categories such as comma-separated value (CSV) formats and/or self-describing formats such as extensible markup language (XML), JavaScript Object Notation (JSON), or the like, enabling processes or devices to detect categories of data.

Alternatively or additionally, and continuing to refer to FIG. 4, training data 404 may include one or more elements that are not categorized; that is, training data 404 may not be formatted or contain descriptors for some elements of data. Machine-learning algorithms and/or other processes may sort training data 404 according to one or more categorizations using, for instance, natural language processing algorithms, tokenization, detection of correlated values in raw data and the like; categories may be generated using correlation and/or other processing algorithms. As a non-limiting example, in a corpus of text, phrases making up a number “n” of compound words, such as nouns modified by other nouns, may be identified according to a statistically significant prevalence of n-grams containing such words in a particular order; such an n-gram may be categorized as an element of language such as a “word” to be tracked similarly to single words, generating a new category as a result of statistical analysis. Similarly, in a data entry including some textual data, a person's name may be identified by reference to a list, dictionary, or other compendium of terms, permitting ad-hoc categorization by machine-learning algorithms, and/or automated association of data in the data entry with descriptors or into a given format. The ability to categorize data entries automatedly may enable the same training data 404 to be made applicable for two or more distinct machine-learning algorithms as described in further detail below. Training data 404 used by machine-learning module 400 may correlate any input data as described in this disclosure to any output data as described in this disclosure. As a non-limiting illustrative example, input data may include contextual data 112, configurable task modifier 148, communication datum 120, communication task datum 152, outcome datum 124, user activity data 128, user data 164, and the like. As a non-limiting illustrative example, output data may include configurable task modifier 148, communication task datum 152, outcome datum 124, task 160, notification datum 176, and the like.

Further referring to FIG. 4, training data may be filtered, sorted, and/or selected using one or more supervised and/or unsupervised machine-learning processes and/or models as described in further detail below; such models may include without limitation a training data classifier 416. Training data classifier 416 may include a “classifier,” which as used in this disclosure is a machine-learning model as defined below, such as a data structure representing and/or using a mathematical model, neural net, or program generated by a machine-learning algorithm known as a “classification algorithm,” as described in further detail below, that sorts inputs into categories or bins of data, outputting the categories or bins of data and/or labels associated therewith. A classifier may be configured to output at least a datum that labels or otherwise identifies a set of data that are clustered together, found to be close under a distance metric as described below, or the like. A distance metric may include any norm, such as, without limitation, a Pythagorean norm. Machine-learning module 400 may generate a classifier using a classification algorithm, defined as a processes whereby a computing device and/or any module and/or component operating thereon derives a classifier from training data 404. Classification may be performed using, without limitation, linear classifiers such as without limitation logistic regression and/or naive Bayes classifiers, nearest neighbor classifiers such as k-nearest neighbors classifiers, support vector machines, least squares support vector machines, fisher's linear discriminant, quadratic classifiers, decision trees, boosted trees, random forest classifiers, learning vector quantization, and/or neural network-based classifiers. As a non-limiting example, training data classifier 416 may classify elements of training data to user cohorts. For example, and without limitation, training data classifier 416 may classify elements of training data to user cohorts related to user's experience, skill, age, gender, industry, position, and the like.

Still referring to FIG. 4, computing device may be configured to generate a classifier using a Naïve Bayes classification algorithm. Naïve Bayes classification algorithm generates classifiers by assigning class labels to problem instances, represented as vectors of element values. Class labels are drawn from a finite set. Naïve Bayes classification algorithm may include generating a family of algorithms that assume that the value of a particular element is independent of the value of any other element, given a class variable. Naïve Bayes classification algorithm may be based on Bayes Theorem expressed as P (A/B)=P (B/A) P (A)=P (B), where P (A/B) is the probability of hypothesis A given data B also known as posterior probability; P (B/A) is the probability of data B given that the hypothesis A was true; P (A) is the probability of hypothesis A being true regardless of data also known as prior probability of A; and P (B) is the probability of the data regardless of the hypothesis. A naïve Bayes algorithm may be generated by first transforming training data into a frequency table. Computing device may then calculate a likelihood table by calculating probabilities of different data entries and classification labels. Computing device may utilize a naïve Bayes equation to calculate a posterior probability for each class. A class containing the highest posterior probability is the outcome of prediction. Naïve Bayes classification algorithm may include a gaussian model that follows a normal distribution. Naïve Bayes classification algorithm may include a multinomial model that is used for discrete counts. Naïve Bayes classification algorithm may include a Bernoulli model that may be utilized when vectors are binary.

With continued reference to FIG. 4, computing device may be configured to generate a classifier using a K-nearest neighbors (KNN) algorithm. A “K-nearest neighbors algorithm” as used in this disclosure, includes a classification method that utilizes feature similarity to analyze how closely out-of-sample-features resemble training data to classify input data to one or more clusters and/or categories of features as represented in training data; this may be performed by representing both training data and input data in vector forms, and using one or more measures of vector similarity to identify classifications within training data, and to determine a classification of input data. K-nearest neighbors algorithm may include specifying a K-value, or a number directing the classifier to select the k most similar entries training data to a given sample, determining the most common classifier of the entries in the database, and classifying the known sample; this may be performed recursively and/or iteratively to generate a classifier that may be used to classify input data as further samples. For instance, an initial set of samples may be performed to cover an initial heuristic and/or “first guess” at an output and/or relationship, which may be seeded, without limitation, using expert input received according to any process as described herein. As a non-limiting example, an initial heuristic may include a ranking of associations between inputs and elements of training data. Heuristic may include selecting some number of highest-ranking associations and/or training data elements.

With continued reference to FIG. 4, generating k-nearest neighbors algorithm may generate a first vector output containing a data entry cluster, generating a second vector output containing an input data, and calculate the distance between the first vector output and the second vector output using any suitable norm such as cosine similarity, Euclidean distance measurement, or the like. Each vector output may be represented, without limitation, as an n-tuple of values, where n is at least two values. Each value of n-tuple of values may represent a measurement or other quantitative value associated with a given category of data, or attribute, examples of which are provided in further detail below; a vector may be represented, without limitation, in n-dimensional space using an axis per category of value represented in n-tuple of values, such that a vector has a geometric direction characterizing the relative quantities of attributes in the n-tuple as compared to each other. Two vectors may be considered equivalent where their directions, and/or the relative quantities of values within each vector as compared to each other, are the same; thus, as a non-limiting example, a vector represented as [5, 10, 15] may be treated as equivalent, for purposes of this disclosure, as a vector represented as [1, 2, 3]. Vectors may be more similar where their directions are more similar, and more different where their directions are more divergent; however, vector similarity may alternatively or additionally be determined using averages of similarities between like attributes, or any other measure of similarity suitable for any n-tuple of values, or aggregation of numerical similarity measures for the purposes of loss functions as described in further detail below. Any vectors as described herein may be scaled, such that each vector represents each attribute along an equivalent scale of values. Each vector may be “normalized,” or divided by a “length” attribute, such as a length attribute/as derived using a Pythagorean norm:

$$l = \sqrt{{\sum }_{i = 0}^{n} {a}_{i}^{2}} ,$$

where aᵢ is attribute number i of the vector. Scaling and/or normalization may function to make vector comparison independent of absolute quantities of attributes, while preserving any dependency on similarity of attributes; this may, for instance, be advantageous where cases represented in training data are represented by different quantities of samples, which may result in proportionally equivalent vectors with divergent values.

With further reference to FIG. 4, training examples for use as training data may be selected from a population of potential examples according to cohorts relevant to an analytical problem to be solved, a classification task, or the like. Alternatively or additionally, training data may be selected to span a set of likely circumstances or inputs for a machine-learning model and/or process to encounter when deployed. For instance, and without limitation, for each category of input data to a machine-learning process or model that may exist in a range of values in a population of phenomena such as images, user data, process data, physical data, or the like, a computing device, processor, and/or machine-learning model may select training examples representing each possible value on such a range and/or a representative sample of values on such a range. Selection of a representative sample may include selection of training examples in proportions matching a statistically determined and/or predicted distribution of such values according to relative frequency, such that, for instance, values encountered more frequently in a population of data so analyzed are represented by more training examples than values that are encountered less frequently. Alternatively or additionally, a set of training examples may be compared to a collection of representative values in a database and/or presented to a user, so that a process can detect, automatically or via user input, one or more values that are not included in the set of training examples. Computing device, processor, and/or module may automatically generate a missing training example; this may be done by receiving and/or retrieving a missing input and/or output value and correlating the missing input and/or output value with a corresponding output and/or input value collocated in a data record with the retrieved value, provided by a user and/or other device, or the like.

Continuing to refer to FIG. 4, computer, processor, and/or module may be configured to preprocess training data. “Preprocessing” training data, as used in this disclosure, is transforming training data from raw form to a format that can be used for training a machine-learning model. Preprocessing may include sanitizing, feature selection, feature scaling, data augmentation and the like.

Still referring to FIG. 4, computer, processor, and/or module may be configured to sanitize training data. “Sanitizing” training data, as used in this disclosure, is a process whereby training examples are removed that interfere with convergence of a machine-learning model and/or process to a useful result. For instance, and without limitation, a training example may include an input and/or output value that is an outlier from typically encountered values, such that a machine-learning algorithm using the training example will be adapted to an unlikely amount as an input and/or output; a value that is more than a threshold number of standard deviations away from an average, mean, or expected value, for instance, may be eliminated. Alternatively or additionally, one or more training examples may be identified as having poor quality data, where “poor quality” is defined as having a signal to noise ratio below a threshold value. Sanitizing may include steps such as removing duplicative or otherwise redundant data, interpolating missing data, correcting data errors, standardizing data, identifying outliers, and the like. In a nonlimiting example, sanitization may include utilizing algorithms for identifying duplicate entries or spell-check algorithms.

As a non-limiting example, and with further reference to FIG. 4, images used to train an image classifier or other machine-learning model and/or process that takes images as inputs or generates images as outputs may be rejected if image quality is below a threshold value. For instance, and without limitation, computing device, processor, and/or module may perform blur detection, and eliminate one or more Blur detection may be performed, as a non-limiting example, by taking Fourier transform, or an approximation such as a Fast Fourier Transform (FFT) of the image and analyzing a distribution of low and high frequencies in the resulting frequency-domain depiction of the image; numbers of high-frequency values below a threshold level may indicate blurriness. As a further non-limiting example, detection of blurriness may be performed by convolving an image, a channel of an image, or the like with a Laplacian kernel; this may generate a numerical score reflecting a number of rapid changes in intensity shown in the image, such that a high score indicates clarity and a low score indicates blurriness. Blurriness detection may be performed using a gradient-based operator, which measures operators based on the gradient or first derivative of an image, based on the hypothesis that rapid changes indicate sharp edges in the image, and thus are indicative of a lower degree of blurriness. Blur detection may be performed using Wavelet-based operator, which takes advantage of the capability of coefficients of the discrete wavelet transform to describe the frequency and spatial content of images. Blur detection may be performed using statistics-based operators take advantage of several image statistics as texture descriptors in order to compute a focus level. Blur detection may be performed by using discrete cosine transform (DCT) coefficients in order to compute a focus level of an image from its frequency content.

Continuing to refer to FIG. 4, computing device, processor, and/or module may be configured to precondition one or more training examples. For instance, and without limitation, where a machine-learning model and/or process has one or more inputs and/or outputs requiring, transmitting, or receiving a certain number of bits, samples, or other units of data, one or more training examples' elements to be used as or compared to inputs and/or outputs may be modified to have such a number of units of data. For instance, a computing device, processor, and/or module may convert a smaller number of units, such as in a low pixel count image, into a desired number of units, for instance by upsampling and interpolating. As a non-limiting example, a low pixel count image may have 100 pixels, however a desired number of pixels may be 128. Processor may interpolate the low pixel count image to convert the 100 pixels into 128 pixels. It should also be noted that one of ordinary skill in the art, upon reading this disclosure, would know the various methods to interpolate a smaller number of data units such as samples, pixels, bits, or the like to a desired number of such units. In some instances, a set of interpolation rules may be trained by sets of highly detailed inputs and/or outputs and corresponding inputs and/or outputs downsampled to smaller numbers of units, and a neural network or other machine-learning model that is trained to predict interpolated pixel values using the training data. As a non-limiting example, a sample input and/or output, such as a sample picture, with sample-expanded data units (e.g., pixels added between the original pixels) may be input to a neural network or machine-learning model and output a pseudo replica sample-picture with dummy values assigned to pixels between the original pixels based on a set of interpolation rules. As a non-limiting example, in the context of an image classifier, a machine-learning model may have a set of interpolation rules trained by sets of highly detailed images and images that have been downsampled to smaller numbers of pixels, and a neural network or other machine-learning model that is trained using those examples to predict interpolated pixel values in a facial picture context. As a result, an input with sample-expanded data units (the ones added between the original data units, with dummy values) may be run through a trained neural network and/or model, which may fill in values to replace the dummy values. Alternatively or additionally, processor, computing device, and/or module may utilize sample expander methods, a low-pass filter, or both. As used in this disclosure, a “low-pass filter” is a filter that passes signals with a frequency lower than a selected cutoff frequency and attenuates signals with frequencies higher than the cutoff frequency. The exact frequency response of the filter depends on the filter design. Computing device, processor, and/or module may use averaging, such as luma or chroma averaging in images, to fill in data units in between original data units.

In some embodiments, and with continued reference to FIG. 4, computing device, processor, and/or module may down-sample elements of a training example to a desired lower number of data elements. As a non-limiting example, a high pixel count image may have 256 pixels, however a desired number of pixels may be 128. Processor may down-sample the high pixel count image to convert the 256 pixels into 128 pixels. In some embodiments, processor may be configured to perform downsampling on data. Downsampling, also known as decimation, may include removing every Nth entry in a sequence of samples, all but every Nth entry, or the like, which is a process known as “compression,” and may be performed, for instance by an N-sample compressor implemented using hardware or software. Anti-aliasing and/or anti-imaging filters, and/or low-pass filters, may be used to clean up side-effects of compression.

Further referring to FIG. 4, feature selection includes narrowing and/or filtering training data to exclude features and/or elements, or training data including such elements, that are not relevant to a purpose for which a trained machine-learning model and/or algorithm is being trained, and/or collection of features and/or elements, or training data including such elements, on the basis of relevance or utility for an intended task or purpose for a trained machine-learning model and/or algorithm is being trained. Feature selection may be implemented, without limitation, using any process described in this disclosure, including without limitation using training data classifiers, exclusion of outliers, or the like.

With continued reference to FIG. 4, feature scaling may include, without limitation, normalization of data entries, which may be accomplished by dividing numerical fields by norms thereof, for instance as performed for vector normalization. Feature scaling may include absolute maximum scaling, wherein each quantitative datum is divided by the maximum absolute value of all quantitative data of a set or subset of quantitative data. Feature scaling may include min-max scaling, in which each value X has a minimum value Xₘᵢₙ in a set or subset of values subtracted therefrom, with the result divided by the range of the values, give maximum value in the set or subset Xₘₐₓ:

$${X}_{new} = \frac{X - {X}_{min}}{{X}_{max} - {X}_{min}} .$$

Feature scaling may include mean normalization, which involves use of a mean value of a set and/or subset of values, Xₘₑₐₙ with maximum and minimum values:

$${X}_{new} = \frac{X - {X}_{mean}}{{X}_{max} - {X}_{min}} .$$

Feature scaling may include standardization, where a difference between X and Xₘₑₐₙ is divided by a standard deviation σ of a set or subset of values:

$${X}_{new} = \frac{X - {X}_{mean}}{σ} .$$

Scaling may be performed using a median value of a set or subset X_{median} and/or interquartile range (IQR), which represents the difference between the 25^{th} percentile value and the 50^{th} percentile value (or closest values thereto by a rounding protocol), such as:

$${X}_{new} = \frac{X - {X}_{median}}{IQR} .$$

Persons skilled in the art, upon reviewing the entirety of this disclosure, will be aware of various alternative or additional approaches that may be used for feature scaling.

Further referring to FIG. 4, computing device, processor, and/or module may be configured to perform one or more processes of data augmentation. “Data augmentation” as used in this disclosure is addition of data to a training set using elements and/or entries already in the dataset. Data augmentation may be accomplished, without limitation, using interpolation, generation of modified copies of existing entries and/or examples, and/or one or more generative AI processes, for instance using deep neural networks and/or generative adversarial networks; generative processes may be referred to alternatively in this context as “data synthesis” and as creating “synthetic data.” Augmentation may include performing one or more transformations on data, such as geometric, color space, affine, brightness, cropping, and/or contrast transformations of images.

Still referring to FIG. 4, machine-learning module 400 may be configured to perform a lazy-learning process 420 and/or protocol, which may alternatively be referred to as a “lazy loading” or “call-when-needed” process and/or protocol, may be a process whereby machine-learning is conducted upon receipt of an input to be converted to an output, by combining the input and training set to derive the algorithm to be used to produce the output on demand. For instance, an initial set of simulations may be performed to cover an initial heuristic and/or “first guess” at an output and/or relationship. As a non-limiting example, an initial heuristic may include a ranking of associations between inputs and elements of training data 404. Heuristic may include selecting some number of highest-ranking associations and/or training data 404 elements. Lazy learning may implement any suitable lazy learning algorithm, including without limitation a K-nearest neighbors algorithm, a lazy naïve Bayes algorithm, or the like; persons skilled in the art, upon reviewing the entirety of this disclosure, will be aware of various lazy-learning algorithms that may be applied to generate outputs as described in this disclosure, including without limitation lazy learning applications of machine-learning algorithms as described in further detail below.

Alternatively or additionally, and with continued reference to FIG. 4, machine-learning processes as described in this disclosure may be used to generate machine-learning models 424. A “machine-learning model,” as used in this disclosure, is a data structure representing and/or instantiating a mathematical and/or algorithmic representation of a relationship between inputs and outputs, as generated using any machine-learning process including without limitation any process as described above, and stored in memory; an input is submitted to a machine-learning model 424 once created, which generates an output based on the relationship that was derived. For instance, and without limitation, a linear regression model, generated using a linear regression algorithm, may compute a linear combination of input data using coefficients derived during machine-learning processes to calculate an output datum. As a further non-limiting example, a machine-learning model 424 may be generated by creating an artificial neural network, such as a convolutional neural network comprising an input layer of nodes, one or more intermediate layers, and an output layer of nodes. Connections between nodes may be created via the process of “training” the network, in which elements from a training data 404 set are applied to the input nodes, a suitable training algorithm (such as Levenberg-Marquardt, conjugate gradient, simulated annealing, or other algorithms) is then used to adjust the connections and weights between nodes in adjacent layers of the neural network to produce the desired values at the output nodes. This process is sometimes referred to as deep learning.

Still referring to FIG. 4, machine-learning algorithms may include at least a supervised machine-learning process 428. At least a supervised machine-learning process 428, as defined herein, include algorithms that receive a training set relating a number of inputs to a number of outputs, and seek to generate one or more data structures representing and/or instantiating one or more mathematical relations relating inputs to outputs, where each of the one or more mathematical relations is optimal according to some criterion specified to the algorithm using some scoring function. For instance, a supervised learning algorithm may include contextual data 112, configurable task modifier 148, communication datum 120, communication task datum 152, outcome datum 124, user activity data 128, user data 164, and the like as described above as inputs, configurable task modifier 148, communication task datum 152, outcome datum 124, task 160, notification datum 176, and the like as outputs, and a scoring function representing a desired form of relationship to be detected between inputs and outputs; scoring function may, for instance, seek to maximize the probability that a given input and/or combination of elements inputs is associated with a given output to minimize the probability that a given input is not associated with a given output. Scoring function may be expressed as a risk function representing an “expected loss” of an algorithm relating inputs to outputs, where loss is computed as an error function representing a degree to which a prediction generated by the relation is incorrect when compared to a given input-output pair provided in training data 404. Persons skilled in the art, upon reviewing the entirety of this disclosure, will be aware of various possible variations of at least a supervised machine-learning process 428 that may be used to determine relation between inputs and outputs. Supervised machine-learning processes may include classification algorithms as defined above.

With further reference to FIG. 4, training a supervised machine-learning process may include, without limitation, iteratively updating coefficients, biases, weights based on an error function, expected loss, and/or risk function. For instance, an output generated by a supervised machine-learning model using an input example in a training example may be compared to an output example from the training example; an error function may be generated based on the comparison, which may include any error function suitable for use with any machine-learning algorithm described in this disclosure, including a square of a difference between one or more sets of compared values or the like. Such an error function may be used in turn to update one or more weights, biases, coefficients, or other parameters of a machine-learning model through any suitable process including without limitation gradient descent processes, least-squares processes, and/or other processes described in this disclosure. This may be done iteratively and/or recursively to gradually tune such weights, biases, coefficients, or other parameters. Updating may be performed, in neural networks, using one or more back-propagation algorithms. Iterative and/or recursive updates to weights, biases, coefficients, or other parameters as described above may be performed until currently available training data is exhausted and/or until a convergence test is passed, where a “convergence test” is a test for a condition selected as indicating that a model and/or weights, biases, coefficients, or other parameters thereof has reached a degree of accuracy. A convergence test may, for instance, compare a difference between two or more successive errors or error function values, where differences below a threshold amount may be taken to indicate convergence. Alternatively or additionally, one or more errors and/or error function values evaluated in training iterations may be compared to a threshold.

Still referring to FIG. 4, a computing device, processor, and/or module may be configured to perform method, method step, sequence of method steps and/or algorithm described in reference to this figure, in any order and with any degree of repetition. For instance, a computing device, processor, and/or module may be configured to perform a single step, sequence and/or algorithm repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. A computing device, processor, and/or module may perform any step, sequence of steps, or algorithm in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

Further referring to FIG. 4, machine-learning processes may include at least an unsupervised machine-learning processes 432. An unsupervised machine-learning process, as used herein, is a process that derives inferences in datasets without regard to labels; as a result, an unsupervised machine-learning process may be free to discover any structure, relationship, and/or correlation provided in the data. Unsupervised processes 432 may not require a response variable; unsupervised processes 432may be used to find interesting patterns and/or inferences between variables, to determine a degree of correlation between two or more variables, or the like.

Still referring to FIG. 4, machine-learning module 400 may be designed and configured to create a machine-learning model 424 using techniques for development of linear regression models. Linear regression models may include ordinary least squares regression, which aims to minimize the square of the difference between predicted outcomes and actual outcomes according to an appropriate norm for measuring such a difference (e.g. a vector-space distance norm); coefficients of the resulting linear equation may be modified to improve minimization. Linear regression models may include ridge regression methods, where the function to be minimized includes the least-squares function plus term multiplying the square of each coefficient by a scalar amount to penalize large coefficients. Linear regression models may include least absolute shrinkage and selection operator (LASSO) models, in which ridge regression is combined with multiplying the least-squares term by a factor of 1 divided by double the number of samples. Linear regression models may include a multi-task lasso model wherein the norm applied in the least-squares term of the lasso model is the Frobenius norm amounting to the square root of the sum of squares of all terms. Linear regression models may include the clastic net model, a multi-task elastic net model, a least angle regression model, a LARS lasso model, an orthogonal matching pursuit model, a Bayesian regression model, a logistic regression model, a stochastic gradient descent model, a perceptron model, a passive aggressive algorithm, a robustness regression model, a Huber regression model, or any other suitable model that may occur to persons skilled in the art upon reviewing the entirety of this disclosure. Linear regression models may be generalized in an embodiment to polynomial regression models, whereby a polynomial equation (e.g. a quadratic, cubic or higher-order equation) providing a best predicted output/actual output fit is sought; similar methods to those described above may be applied to minimize error functions, as will be apparent to persons skilled in the art upon reviewing the entirety of this disclosure.

Continuing to refer to FIG. 4, machine-learning algorithms may include, without limitation, linear discriminant analysis. Machine-learning algorithm may include quadratic discriminant analysis. Machine-learning algorithms may include kernel ridge regression. Machine-learning algorithms may include support vector machines, including without limitation support vector classification-based regression processes. Machine-learning algorithms may include stochastic gradient descent algorithms, including classification and regression algorithms based on stochastic gradient descent. Machine-learning algorithms may include nearest neighbors algorithms. Machine-learning algorithms may include various forms of latent space regularization such as variational regularization. Machine-learning algorithms may include Gaussian processes such as Gaussian Process Regression. Machine-learning algorithms may include cross-decomposition algorithms, including partial least squares and/or canonical correlation analysis. Machine-learning algorithms may include naïve Bayes methods. Machine-learning algorithms may include algorithms based on decision trees, such as decision tree classification or regression algorithms. Machine-learning algorithms may include ensemble methods such as bagging meta-estimator, forest of randomized trees, AdaBoost, gradient tree boosting, and/or voting classifier methods. Machine-learning algorithms may include neural net algorithms, including convolutional neural net processes.

Still referring to FIG. 4, a machine-learning model and/or process may be deployed or instantiated by incorporation into a program, apparatus, system and/or module. For instance, and without limitation, a machine-learning model, neural network, and/or some or all parameters thereof may be stored and/or deployed in any memory or circuitry. Parameters such as coefficients, weights, and/or biases may be stored as circuit-based constants, such as arrays of wires and/or binary inputs and/or outputs set at logic “1” and “0” voltage levels in a logic circuit to represent a number according to any suitable encoding system including twos complement or the like or may be stored in any volatile and/or non-volatile memory. Similarly, mathematical operations and input and/or output of data to or from models, neural network layers, or the like may be instantiated in hardware circuitry and/or in the form of instructions in firmware, machine-code such as binary operation code instructions, assembly language, or any higher-order programming language. Any technology for hardware and/or software instantiation of memory, instructions, data structures, and/or algorithms may be used to instantiate a machine-learning process and/or model, including without limitation any combination of production and/or configuration of non-reconfigurable hardware elements, circuits, and/or modules such as without limitation ASICs, production and/or configuration of reconfigurable hardware elements, circuits, and/or modules such as without limitation FPGAs, production and/or of non-reconfigurable and/or configuration non-rewritable memory elements, circuits, and/or modules such as without limitation non-rewritable ROM, production and/or configuration of reconfigurable and/or rewritable memory elements, circuits, and/or modules such as without limitation rewritable ROM or other memory technology described in this disclosure, and/or production and/or configuration of any computing device and/or component thereof as described in this disclosure. Such deployed and/or instantiated machine-learning model and/or algorithm may receive inputs from any other process, module, and/or component described in this disclosure, and produce outputs to any other process, module, and/or component described in this disclosure.

Continuing to refer to FIG. 4, any process of training, retraining, deployment, and/or instantiation of any machine-learning model and/or algorithm may be performed and/or repeated after an initial deployment and/or instantiation to correct, refine, and/or improve the machine-learning model and/or algorithm. Such retraining, deployment, and/or instantiation may be performed as a periodic or regular process, such as retraining, deployment, and/or instantiation at regular elapsed time periods, after some measure of volume such as a number of bytes or other measures of data processed, a number of uses or performances of processes described in this disclosure, or the like, and/or according to a software, firmware, or other update schedule. Alternatively or additionally, retraining, deployment, and/or instantiation may be event-based, and may be triggered, without limitation, by user inputs indicating sub-optimal or otherwise problematic performance and/or by automated field testing and/or auditing processes, which may compare outputs of machine-learning models and/or algorithms, and/or errors and/or error functions thereof, to any thresholds, convergence tests, or the like, and/or may compare outputs of processes described herein to similar thresholds, convergence tests or the like. Event-based retraining, deployment, and/or instantiation may alternatively or additionally be triggered by receipt and/or generation of one or more new training examples; a number of new training examples may be compared to a preconfigured threshold, where exceeding the preconfigured threshold may trigger retraining, deployment, and/or instantiation.

Still referring to FIG. 4, retraining and/or additional training may be performed using any process for training described above, using any currently or previously deployed version of a machine-learning model and/or algorithm as a starting point. Training data for retraining may be collected, preconditioned, sorted, classified, sanitized or otherwise processed according to any process described in this disclosure. Training data may include, without limitation, training examples including inputs and correlated outputs used, received, and/or generated from any version of any system, module, machine-learning model or algorithm, apparatus, and/or method described in this disclosure; such examples may be modified and/or labeled according to user feedback or other processes to indicate desired results, and/or may have actual or measured results from a process being modeled and/or predicted by system, module, machine-learning model or algorithm, apparatus, and/or method as “desired” results to be compared to outputs for training processes as described above.

Redeployment may be performed using any reconfiguring and/or rewriting of reconfigurable and/or rewritable circuit and/or memory elements; alternatively, redeployment may be performed by production of new hardware and/or software components, circuits, instructions, or the like, which may be added to and/or may replace existing hardware and/or software components, circuits, instructions, or the like.

Further referring to FIG. 4, one or more processes or algorithms described above may be performed by at least a dedicated hardware unit 436. A “dedicated hardware unit,” for the purposes of this figure, is a hardware component, circuit, or the like, aside from a principal control circuit and/or processor performing method steps as described in this disclosure, that is specifically designated or selected to perform one or more specific tasks and/or processes described in reference to this figure, such as without limitation preconditioning and/or sanitization of training data and/or training a machine-learning algorithm and/or model. A dedicated hardware unit 436 may include, without limitation, a hardware unit that can perform iterative or massed calculations, such as matrix-based calculations to update or tune parameters, weights, coefficients, and/or biases of machine-learning models and/or neural networks, efficiently using pipelining, parallel processing, or the like; such a hardware unit may be optimized for such processes by, for instance, including dedicated circuitry for matrix and/or signal processing operations that includes, e.g., multiple arithmetic and/or logical circuit units such as multipliers and/or adders that can act simultaneously and/or in parallel or the like. Such dedicated hardware units 436 may include, without limitation, graphical processing units (GPUs), dedicated signal processing modules, FPGA or other reconfigurable hardware that has been configured to instantiate parallel processing units for one or more specific tasks, or the like, A computing device, processor, apparatus, or module may be configured to instruct one or more dedicated hardware units 436 to perform one or more operations described herein, such as evaluation of model and/or algorithm outputs, one-time or iterative updates to parameters, coefficients, weights, and/or biases, and/or any other operations such as vector and/or matrix operations as described in this disclosure.

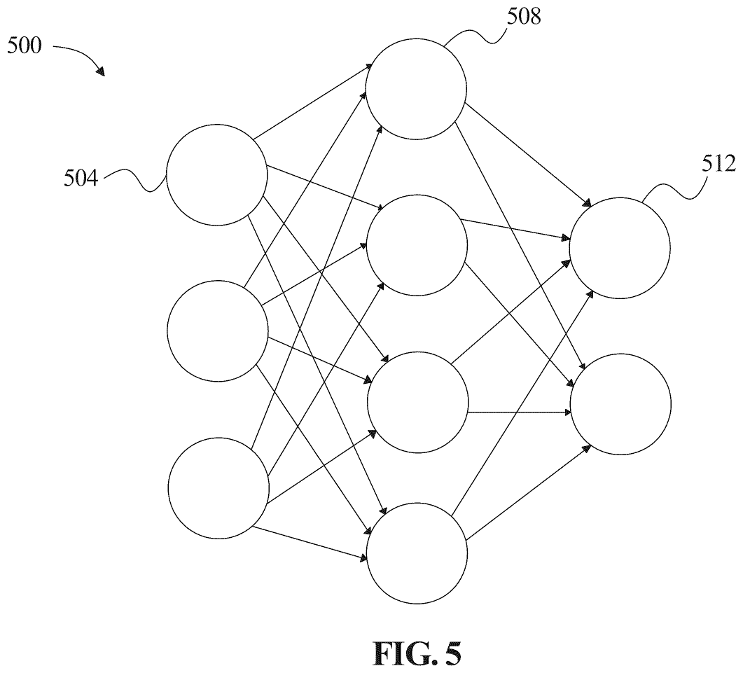

Referring now to FIG. 5, an exemplary embodiment of neural network 500 is illustrated. A neural network 500 also known as an artificial neural network, is a network of “nodes,” or data structures having one or more inputs, one or more outputs, and a function determining outputs based on inputs. Such nodes may be organized in a network, such as without limitation a convolutional neural network, including an input layer of nodes 504, one or more intermediate layers 508, and an output layer of nodes 512. Connections between nodes may be created via the process of “training” the network, in which elements from a training dataset are applied to the input nodes, a suitable training algorithm (such as Levenberg-Marquardt, conjugate gradient, simulated annealing, or other algorithms) is then used to adjust the connections and weights between nodes in adjacent layers of the neural network to produce the desired values at the output nodes. This process is sometimes referred to as deep learning. Connections may run solely from input nodes toward output nodes in a “feed-forward” network, or may feed outputs of one layer back to inputs of the same or a different layer in a “recurrent network.” As a further non-limiting example, a neural network may include a convolutional neural network comprising an input layer of nodes, one or more intermediate layers, and an output layer of nodes. A “convolutional neural network,” as used in this disclosure, is a neural network in which at least one hidden layer is a convolutional layer that convolves inputs to that layer with a subset of inputs known as a “kernel,” along with one or more additional layers such as pooling layers, fully connected layers, and the like.

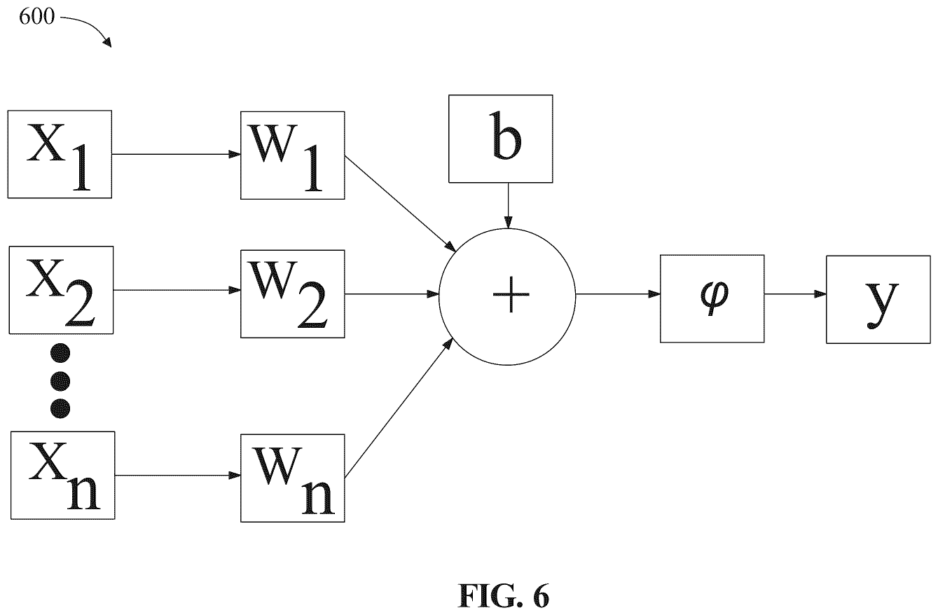

Referring now to FIG. 6, an exemplary embodiment of a node 600 of a neural network is illustrated. A node may include, without limitation a plurality of inputs x; that may receive numerical values from inputs to a neural network containing the node and/or from other nodes. Node may perform one or more activation functions to produce its output given one or more inputs, such as without limitation computing a binary step function comparing an input to a threshold value and outputting either a logic 1 or logic 0 output or something equivalent, a linear activation function whereby an output is directly proportional to the input, and/or a non-linear activation function, wherein the output is not proportional to the input. Non-linear activation functions may include, without limitation, a sigmoid function of the form:

$$f ( x ) = \frac{1}{1 - {e}^{- x}}$$

given input x, a tanh (hyperbolic tangent) function, of the form

$$\frac{{e}^{x} - {e}^{- x}}{{e}^{x} + {e}^{- x}} ,$$

a tanh derivative function such as f(x)=tanh²(x), a rectified linear unit function such as f(x)=max(0, x), a “leaky” and/or “parametric” rectified linear unit function such as f(x)=max(ax, x) for some a, an exponential linear units function such as

$$f ( x ) = \{ \begin{matrix}x for x \geq 0 \\ α ( {e}^{x} - 1 ) for x < 0\end{matrix}$$

for some value of α (this function may be replaced and/or weighted by its own derivative in some embodiments), a softmax function such as

$$f ( {x}_{i} ) = \frac{{e}^{x}}{{\sum }_{i} {x}_{i}}$$

where the inputs to an instant layer are xᵢ, a swish function such as f(x)=x*sigmoid(x), a Gaussian error linear unit function such as f(x)=a(1+tanh(\sqrt{2/π}(x+bx^{r}))) for some values of a, b, and r, and/or a scaled exponential linear unit function such as

$$f ( x ) = λ \{ \begin{matrix}α ( {e}^{x} - 1 ) for x < 0 \\ x for x \geq 0\end{matrix} .$$

Fundamentally, there is no limit to the nature of functions of inputs x; that may be used as activation functions. As a non-limiting and illustrative example, node may perform a weighted sum of inputs using weights w; that are multiplied by respective inputs xᵢ. Additionally or alternatively, a bias b may be added to the weighted sum of the inputs such that an offset is added to each unit in the neural network layer that is independent of the input to the layer. The weighted sum may then be input into a function φ, which may generate one or more outputs y. Weight wᵢ applied to an input x; may indicate whether the input is “excitatory,” indicating that it has strong influence on the one or more outputs y, for instance by the corresponding weight having a large numerical value, and/or a “inhibitory,” indicating it has a weak effect influence on the one more inputs y, for instance by the corresponding weight having a small numerical value. The values of weights wᵢ may be determined by training a neural network using training data, which may be performed using any suitable process as described above.

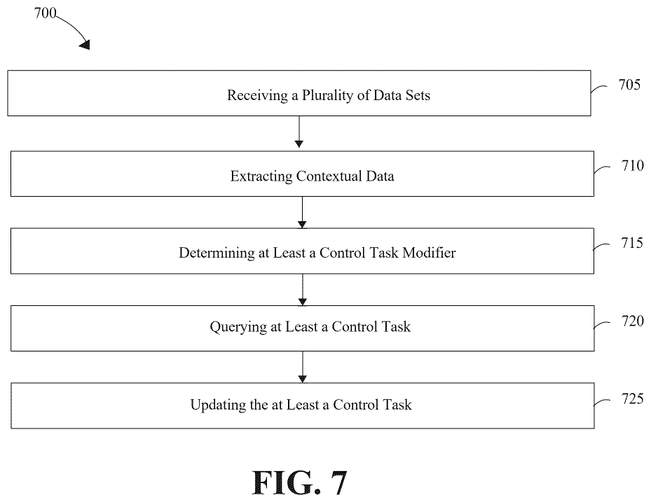

Referring now to FIG. 7, a flow diagram of an exemplary method 700 for automatic task control is illustrated. Method 700 contains a step 705 of receiving, using a receiving module operating on at least a server, a plurality of data sets from one or more data source. In some embodiments, the plurality of data sets may include a communication datum and the one or more data sources may include a communication channel. In some embodiments, the plurality of data sets may include an outcome datum and the one or more data sources comprises an outcome machine-learning module. In some embodiments, the plurality of data sets may include user activity data, wherein the user activity data may include interactions of the user with a graphical user interface element related to the plurality of tasks and the one or more data sources may include at least a downstream device. These may be implemented as reference to FIGS. 1-6.

With continued reference to FIG. 7, method 700 contains a step 710 of extracting, using a receiving module, contextual data associated with a plurality of tasks from a plurality of data sets. In some embodiments, extracting the contextual data may include converting, using an automatic speech recognition, the communication datum in an audio format into a textual format and extracting the contextual data as a function of the communication datum in the textual format. These may be implemented as reference to FIGS. 1-6.

With continued reference to FIG. 7, method 700 contains a step 715 of determining, using a context analyzing module operating on at least a server, at least a configurable task modifier as a function of contextual data. In some embodiments, determining the at least a configurable task modifier may include extracting, using a language processing module of the context analyzing module, at least a communication task datum from the contextual data and determining the at least a configurable task modifier as a function of the at least a communication task datum. In some embodiments, determining the configurable task modifier may include generating analysis training data, wherein the analysis training data may include exemplary context data correlated to exemplary configurable task modifiers, training an analysis machine-learning model using the analysis training data and determining the configurable task modifier using the trained analysis machine-learning model. These may be implemented as reference to FIGS. 1-6.

With continued reference to FIG. 7, method 700 contains a step 720 of querying, using a task update module operating on at least a server, a plurality of tasks to identify at least one task of the plurality of tasks as a function of at least a configurable task modifier. This may be implemented as reference to FIGS. 1-6.

With continued reference to FIG. 7, method 700 contains a step 725 of updating, using a task update module operating on at least a server, at least one task as a function of at least a configurable task modifier. In some embodiments, updating the at least a task may include receiving user data pertaining to a plurality of users, identifying, using the task update module, at least one user identifier associated with at least a user of the plurality of users as a function of the user data and the at least a configurable task modifier and linking the at least one task to the at least one user identifier. In some embodiments, updating the at least a task may include receiving a user response datum related to the at least a configurable task modifier, wherein the user response datum may include an action modification and updating the at least a task as a function of the user response datum. In some embodiments, method 700 may further include generating, using a communication module operating on the at least a server, a notification datum as a function of the update of the at least a task and transmitting, using the communication module, the notification datum to at least a downstream device. These may be implemented as reference to FIGS. 1-6.

It is to be noted that any one or more of the aspects and embodiments described herein may be conveniently implemented using one or more machines (e.g., one or more computing devices that are utilized as a user computing device for an electronic document, one or more server devices, such as a document server, etc.) programmed according to the teachings of the present specification, as will be apparent to those of ordinary skill in the computer art. Appropriate software coding can readily be prepared by skilled programmers based on the teachings of the present disclosure, as will be apparent to those of ordinary skill in the software art. Aspects and implementations discussed above employing software and/or software modules may also include appropriate hardware for assisting in the implementation of the machine executable instructions of the software and/or software module.

Such software may be a computer program product that employs a machine-readable storage medium. A machine-readable storage medium may be any medium that is capable of storing and/or encoding a sequence of instructions for execution by a machine (e.g., a computing device) and that causes the machine to perform any one of the methodologies and/or embodiments described herein. Examples of a machine-readable storage medium include, but are not limited to, a magnetic disk, an optical disc (e.g., CD, CD-R, DVD, DVD-R, etc.), a magneto-optical disk, a read-only memory “ROM” device, a random access memory “RAM” device, a magnetic card, an optical card, a solid-state memory device, an EPROM, an EEPROM, and any combinations thereof. A machine-readable medium, as used herein, is intended to include a single medium as well as a collection of physically separate media, such as, for example, a collection of compact discs or one or more hard disk drives in combination with a computer memory. As used herein, a machine-readable storage medium does not include transitory forms of signal transmission.

Such software may also include information (e.g., data) carried as a data signal on a data carrier, such as a carrier wave. For example, machine-executable information may be included as a data-carrying signal embodied in a data carrier in which the signal encodes a sequence of instruction, or portion thereof, for execution by a machine (e.g., a computing device) and any related information (e.g., data structures and data) that causes the machine to perform any one of the methodologies and/or embodiments described herein.

Examples of a computing device include, but are not limited to, an electronic book reading device, a computer workstation, a terminal computer, a server computer, a handheld device (e.g., a tablet computer, a smartphone, etc.), a web appliance, a network router, a network switch, a network bridge, any machine capable of executing a sequence of instructions that specify an action to be taken by that machine, and any combinations thereof. In one example, a computing device may include and/or be included in a kiosk.

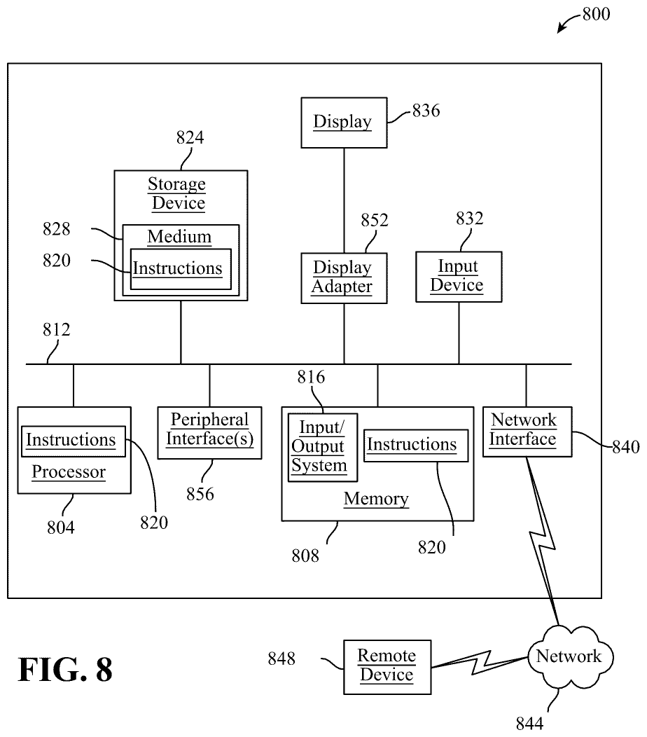

FIG. 8 shows a diagrammatic representation of one embodiment of a computing device in the exemplary form of a computer system 800 within which a set of instructions for causing a control system to perform any one or more of the aspects and/or methodologies of the present disclosure may be executed. It is also contemplated that multiple computing devices may be utilized to implement a specially configured set of instructions for causing one or more of the devices to perform any one or more of the aspects and/or methodologies of the present disclosure. Computer system 800 includes a processor 804 and memory 808 that communicate with each other, and with other components, via a bus 812. Bus 812 may include any of several types of bus structures including, but not limited to, memory bus, memory controller, a peripheral bus, a local bus, and any combinations thereof, using any of a variety of bus architectures.

Processor 804 may include any suitable processor, such as without limitation a processor incorporating logical circuitry for performing arithmetic and logical operations, such as an arithmetic and logic unit (ALU), which may be regulated with a state machine and directed by operational inputs from memory and/or sensors; processor 804 may be organized according to Von Neumann and/or Harvard architecture as a non-limiting example. Processor 804 may include, incorporate, and/or be incorporated in, without limitation, a microcontroller, microprocessor, digital signal processor (DSP), Field Programmable Gate Array (FPGA), Complex Programmable Logic Device (CPLD), Graphical Processing Unit (GPU), general purpose GPU, Tensor Processing Unit (TPU), analog or mixed signal processor, Trusted Platform Module (TPM), a floating point unit (FPU), and/or system on a chip (SoC).

Memory 808 may include various components (e.g., machine-readable media) including, but not limited to, a random-access memory component, a read only component, and any combinations thereof. In one example, a basic input/output system 816 (BIOS), including basic routines that help to transfer information between elements within computer system 800, such as during start-up, may be stored in memory 808. Memory 808 may also include (e.g., stored on one or more machine-readable media) instructions (e.g., software) 820 embodying any one or more of the aspects and/or methodologies of the present disclosure. In another example, memory 808 may further include any number of program modules including, but not limited to, an operating system, one or more application programs, other program modules, program data, and any combinations thereof.

Computer system 800 may also include a storage device 824. Examples of a storage device (e.g., storage device 824) include, but are not limited to, a hard disk drive, a magnetic disk drive, an optical disc drive in combination with an optical medium, a solid-state memory device, and any combinations thereof. Storage device 824 may be connected to bus 812 by an appropriate interface (not shown). Example interfaces include, but are not limited to, SCSI, advanced technology attachment (ATA), serial ATA, universal serial bus (USB), IEEE 1394 (FIREWIRE), and any combinations thereof. In one example, storage device 824 (or one or more components thereof) may be removably interfaced with computer system 800 (e.g., via an external port connector (not shown)). Particularly, storage device 824 and an associated machine-readable medium 828 may provide nonvolatile and/or volatile storage of machine-readable instructions, data structures, program modules, and/or other data for computer system 800. In one example, software 820 may reside, completely or partially, within machine-readable medium 828. In another example, software 820 may reside, completely or partially, within processor 804.

Computer system 800 may also include an input device 832. In one example, a user of computer system 800 may enter commands and/or other information into computer system 800 via input device 832. Examples of an input device 832 include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), a touchscreen, and any combinations thereof. Input device 832 may be interfaced to bus 812 via any of a variety of interfaces (not shown) including, but not limited to, a serial interface, a parallel interface, a game port, a USB interface, a FIREWIRE interface, a direct interface to bus 812, and any combinations thereof. Input device 832 may include a touch screen interface that may be a part of or separate from display device 836, discussed further below. Input device 832 may be utilized as a user selection device for selecting one or more graphical representations in a graphical interface as described above.

A user may also input commands and/or other information to computer system 800 via storage device 824 (e.g., a removable disk drive, a flash drive, etc.) and/or network interface device 840. A network interface device, such as network interface device 840, may be utilized for connecting computer system 800 to one or more of a variety of networks, such as network 844, and one or more remote devices 848 connected thereto. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network, such as network 844, may employ a wired and/or a wireless mode of communication. In general, any network topology may be used. Information (e.g., data, software 820, etc.) may be communicated to and/or from computer system 800 via network interface device 840.

Computer system 800 may further include a video display adapter 852 for communicating a displayable image to a display device, such as display device 836. Examples of a display device include, but are not limited to, a liquid crystal display (LCD), a cathode ray tube (CRT), a plasma display, a light emitting diode (LED) display, and any combinations thereof. Display adapter 852 and display device 836 may be utilized in combination with processor 804 to provide graphical representations of aspects of the present disclosure. In addition to a display device, computer system 800 may include one or more other peripheral output devices including, but not limited to, an audio speaker, a printer, and any combinations thereof. Such peripheral output devices may be connected to bus 812 via a peripheral interface 856. Examples of a peripheral interface include, but are not limited to, a serial port, a USB connection, a FIREWIRE connection, a parallel connection, and any combinations thereof.

The foregoing has been a detailed description of illustrative embodiments of the invention. Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present invention. Additionally, although particular methods herein may be illustrated and/or described as being performed in a specific order, the ordering is highly variable within ordinary skill to achieve methods, systems, and software according to the present disclosure. Accordingly, this description is meant to be taken only by way of example, and not to otherwise limit the scope of this invention.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

1. A system for automatic task control, the system comprising:
at least a server;
a receiving module operating on the at least a server, wherein the receiving module is designed and configured to:
receive a plurality of data sets from one or more data sources, wherein
the plurality of data sets comprises a communication datum in text or audio format; and
wherein receiving the plurality of data sets from the one or more data sources comprises instantiating a chatbot, wherein the chatbot is configured to respond to input using a decision tree, wherein the decision tree comprises at least:
a root node, wherein the root node is configured to receive the input; and
a terminal node corresponding to an exit indication;
extract contextual data associated with a plurality of tasks from the plurality of data sets;
a context analyzing module operating on the at least a server, wherein the context analyzing module is designed and configured to:
determine at least a configurable task modifier as a function of the contextual data using an analysis machine-learning model which comprises:
converting at least communication datum in audio format into a form of machine-readable code using an automatic speech recognition process implementing cepstral normalization to normalize for different speakers and recording conditions and extracting contextual data;
receiving analysis training data from a task update database communicatively connected to the server, wherein the analysis training data correlates a plurality of exemplary context data to a plurality of exemplary configurable task modifier data, wherein the task database comprises keywords that match elements to each other;
training, iteratively, the analysis machine-learning model using the analysis training data, wherein training the analysis machine learning model includes retraining the analysis machine-learning model with feedback from previous iterations of the analysis machine-learning model;
determining the configurable task modifier using the trained analysis machine-learning model; and
a task update module operating on the at least a server, wherein the task update module is designed and configured to:
query the plurality of tasks to identify at least one task of the plurality of tasks as a function of the at least a configurable task modifier; and
update the at least one task comprising a calendar event as a function of the at least a configurable task modifier and the trained analysis machine-learning model.

2. (canceled)

3. The system of claim 1, wherein the one or more data sources comprises a communication channel and extracting the contextual data comprises:
converting, using an automatic speech recognition, the communication datum in an audio format into a textual format; and
extracting the contextual data as a function of the communication datum in the textual format.

4. The system of claim 1, wherein determining the at least a configurable task modifier comprises:
extracting, using a language processing module of the context analyzing module, at least a communication task datum from the contextual data; and
determining the at least a configurable task modifier as a function of the at least a communication task datum.

5. The system of claim 1, wherein:
the plurality of data sets comprises an outcome datum; and
the one or more data sources comprises an outcome machine-learning module.

6. The system of claim 1, wherein:
the plurality of data sets comprises user activity data, wherein the user activity data comprises interactions of the user with a graphical user interface element related to the plurality of tasks; and
the one or more data sources comprises at least a downstream device.

7. (canceled)

8. The system of claim 1, wherein updating the at least a task comprises:
receiving user data pertaining to a plurality of users;
identifying, using the task update module, at least one user identifier associated with at least a user of the plurality of users as a function of the user data and the at least a configurable task modifier; and
linking the at least one task to the at least one user identifier.

9. The system of claim 1, wherein updating the at least a task comprises:
receiving a user response datum related to the at least a configurable task modifier, wherein the user response datum comprises an action modification; and
updating the at least a task as a function of the user response datum.

10. The system of claim 1, further comprising:
a communication module operating on the at least a server, wherein the communication module is designed and configured to:
generate a notification datum as a function of the update of the at least a task; and
transmit the notification datum to at least a downstream device.

11. A method for automatic task control, the method comprising:
receiving, using a receiving module operating on at least a server, a plurality of data sets from one or more data sources, wherein the plurality of data sets comprises a communication datum in text or audio format, wherein receiving the plurality of data sets from the one or more data sources comprises instantiating a chatbot, wherein the chatbot is configured to respond to input using a decision tree, wherein the decision tree comprises at least:
a root node, wherein the root node is configured to receive the input; and
a terminal node corresponding to an exit indication;
extracting, using the receiving module, contextual data associated with a plurality of tasks from the plurality of data sets;
determining, using a context analyzing module operating on the at least a server, at least a configurable task modifier as a function of the contextual data using an analysis machine-learning model which comprises:
converting at least communication datum in audio format into a form of machine-readable code using an automatic speech recognition process implementing cepstral normalization to normalize for different speakers and recording conditions and extracting contextual data;
receiving analysis training data from a task update database communicatively connected to the server, wherein the analysis training data correlates a plurality of exemplary context data to a plurality of exemplary configurable task modifier data, wherein the task database comprises keywords that match elements to each other;
training, iteratively, the analysis machine-learning model using the analysis training data, wherein training the analysis machine-learning model includes retraining the analysis machine-learning model with feedback from previous iterations of the analysis machine-learning model;
determining the configurable task modifier using the trained analysis machine-learning model;
querying, using a task update module operating on the at least a server, the plurality of tasks to identify at least one task of the plurality of tasks as a function of the at least a configurable task modifier; and
updating, using a task update module operating on the at least a server, the at least one task comprising a calendar event as a function of the at least a configurable task modifier and the trained analysis machine-learning model.

12. (canceled)

13. The method of claim 11, wherein the one or more data sources comprises a communication channel and extracting the contextual data comprises:
converting, using an automatic speech recognition, the communication datum in an audio format into a textual format; and
extracting the contextual data as a function of the communication datum in the textual format.

14. The method of claim 11, wherein determining the at least a configurable task modifier comprises:
extracting, using a language processing module of the context analyzing module, at least a communication task datum from the contextual data; and
determining the at least a configurable task modifier as a function of the at least a communication task datum.

15. The method of claim 11, wherein:
the plurality of data sets comprises an outcome datum; and
the one or more data sources comprises an outcome machine-learning module.

16. The method of claim 11, wherein:
the plurality of data sets comprises user activity data, wherein the user activity data comprises interactions of the user with a graphical user interface element related to the plurality of tasks; and
the one or more data sources comprises at least a downstream device.

17. (canceled)

18. The method of claim 11, wherein updating the at least a task comprises:
receiving user data pertaining to a plurality of users;
identifying, using the task update module, at least one user identifier associated with at least a user of the plurality of users as a function of the user data and the at least a configurable task modifier; and
linking the at least one task to the at least one user identifier.

19. The method of claim 11, wherein updating the at least a task comprises:
receiving a user response datum related to the at least a configurable task modifier, wherein the user response datum comprises an action modification; and
updating the at least a task as a function of the user response datum.

20. The method of claim 11, further comprising:
generating, using a communication module operating on the at least a server, a notification datum as a function of the update of the at least a task; and
transmitting, using the communication module, the notification datum to at least a downstream device.

21. The system of claim 1, wherein the plurality of data sets further comprises user activity data, wherein the user activity data comprises a number of logins, session durations, and actions performed per session.

22. The method of claim 11, wherein the plurality of data sets further comprises user activity data, wherein the user activity data comprises a number of logins, session durations, and actions performed per session.

23. The system of claim 1, wherein training the analysis machine-learning model further includes:
applying elements from the analysis training data to an input set of nodes of a neural network; and
adjusting, using a training algorithm the connections and weights of nodes in adjacent layers of the neural network to produce desired values at an output set of nodes.

24. The method of claim 11, wherein training the analysis machine-learning model further includes:
applying elements from the analysis training data to an input set of nodes of a neural network; and
adjusting, using a training algorithm the connections and weights of nodes in adjacent layers of the neural network to produce desired values at an output set of nodes.
